(19) United States
(12) Patent Application Publication
(10) Pub. No.: US 2011/0141134 A1
(43) Pub. Date: Jun. 16, 2011

(54) ENCODER AND DISPLAY CONTROLLER

(75) Inventor: Hisashi Sasaki, Kanagawa-Ken (JP)

(73) Assignee: Kabushiki Kaisha Toshiba, Tokyo (JP)

(21) Appl. No.: 12/831,489

(22) Filed: Jul. 7, 2010

(30) Foreign Application Priority Data
Dec. 11, 2009 (JP) 2009-281822

(51) Int. Cl. G09G 5/02; G06K 9/36

(52) U.S. Cl. 345/600; 382/166

(57) ABSTRACT

In one embodiment, an encoder has a first color sorting unit, a second color sorting unit and an encoding unit. The first color sorting unit divides along a first color axis, each of pixel blocks each having an inputted plurality of pixels, into m regions where m is an integer of two or more, to classify the plurality of pixels in each of the pixel blocks into the m regions, and to calculate a minimum value, a maximum value and an average value of pixel values belonging to each of the m regions for each of the m regions. The second color sorting unit divides along a second axis selected based on a calculation of the first color sorting unit, each of the m regions into n sub-regions where n is an integer of two or more, for each of the m regions, to classify the plurality of pixels in the pixel block into (m×n) sub-regions, and to calculate coded information corresponding to representative colors allocated to pixel locations in an original pixel block and bitmap information of the representative colors. The encoding unit generates coded data of the pixel values of the plurality of pixels in the pixel block corresponding to the (m×n) sub-regions based on differences between the representative values corresponding to the representative colors in the (m×n) sub-regions.

### CROSS REFERENCE TO RELATED APPLICATIONS

This application is based upon and claims the benefit of priority from the prior Japanese Patent Application No. 2009-281822, filed on Dec. 11, 2009, the entire contents of which are incorporated herein by reference.

### FIELD

The present invention relates to an encoder and a display controller for generating coded data of compressed pixel data.

### BACKGROUND

Many techniques have been proposed for efficient compression which treats a large amount of image data with less degradation of image quality.

DCT (Discrete Cosine Transform) and wavelet transformation is well-known as schemes of image compression. Although these transformation techniques achieve very high compression rate, there is a problem that hardware size is large. You may suppose the trial that hardware size is reduced by the reduction of processing block size, which has lower compression rate. In this trial, adjustment of quantization-step has unbalance related to the positional sides of screen: left or right. By this unbalance, edge-errors are visible on the left side of screen.

A technique using DPCM (Differential Pulse Code Modulation) is also well-known (see, U.S. Patent Application Pub. No. 2008/0131087A1 and EP Patent Application Pub. No. 1978746A2). Although this technique also achieves high image quality, there is a problem that the compression rate is still not so high.

The other schemes are also known for achieving a relatively high compression rate. Three typical schemes will be briefly shown below.

The first one is local color quantization (see, G. Qiu, “Coding Color Quantized Images by Local Color Quantization”, The sixth Color Image Conference: Color Science, Systems, and Applications, 1998, IS&T pp. 206-207, section 3: Local Color Quantization and of Color Quantized Images).

In this scheme, “K-means” is used to calculate representative colors. In more detail, calculation is repeated until optimum values of representative colors are obtained. This scheme is not suitable for real-time processing, because calculation is performed too repeatedly, even if its unit calculation is executed so fast. Moreover, we experimentally know the fact that images artificially generated by PCs (such as icon images) have three or more colors in most cases, even for small-size pixel block. So, we are afraid that such artificially generated images may have significant degradation for the worse case that internal compression data has two representative colors.

The second one is texture compression (see, U.S. Pat. No. 7,043,087). For the texture compression, its encoding is usually executed in advance, prior to primary image processing. Its decoding is executed by real-time processing. Its encoding is executed by software with rather slow processing speed than hardware in general, so that real-time processing is not considered for encoding.

Different from the texture compression, the following document proposes a technique for full real-time processing in encoding: Oskar Alexanderson, Christoffer Gurell, “Compressing Dynamically Generated Textures on the GPU,” thesis for a diploma in computer science, Department of Computer Science, Faculty of Science, Lund University, 2006 (Available from graphics. Cs. 1th. se/research/papars/gputc2006/thesis. Pdf, extended paper for ACM SIGGRAPG 2006 P-80, page 4-17 (section 3.2 algorism in detail).

In this technique, GPU performs processing to determine representative colors. This means the drawback that this technique cannot be implemented in small hardware without GPUs. Moreover, the texture compression achieve higher compression rate by deriving representative colors based on the linear approximation of representative colors. This linear approximation tends to cause juddering and thus image degradation.

The third one is BTC (Block Truncation Code), (see, Jun Someya et al. “Development of Single Chip Overdrive LSI with Embedded Frame Memory,” SID 2008, 33. 2 page 464-465, section 2: hcFFD using SRAM-based frame memory). The conventional BTC tends to cause juddering and thus significant image degradation.

### BRIEF DESCRIPTION OF THE DRAWINGS

FIG. 1 illustrates the configuration of a liquid crystal display apparatus provided with an encoder according to a first embodiment of the present invention;

FIG. 2 shows a detailed configuration of the TCON 2;

FIG. 3 is a flowchart showing an example of encoding executed by the ENC 4 in FIG. 1;

FIG. 4 is a flowchart showing an example of detail of step S3 in FIG. 3;

FIG. 5 is a flowchart showing a detail of step S11 in FIG. 4;

FIG. 6 illustrates threshold values 1 to 3 are set on the primary color axis;

FIG. 7 illustrates an example of a block classified by four along a Y-axis as the primary color axis;

FIG. 8 illustrates the second division;

FIG. 9A illustrates all candidates in division for regions 1 and 2;

FIG. 9B illustrates all candidates in division for regions 3 and 4;

FIG. 10 illustrates an example of bitmap;

FIG. 11 is a flowchart showing an example of detail of step S12 in FIG. 4;

FIGS. 12(a), 12(b) and 12(c) illustrate a difference mode for a component Y;

FIGS. 13(a), 13(b), 13(c) and 13(d) illustrate difference modes for components Cb and Cr;

FIGS. 14(a), 14(b), 14(c), 14(d) and 14(e) illustrate encoded data which are generated by the ENC 4;

FIG. 15 illustrates an example of encoded data format;

FIG. 16 is a flowchart showing an example of decoding executed by the DEC 6 in FIG. 1;

FIG. 17 is a flowchart showing an example of detail of step S43 in FIG. 16;

FIG. 18 illustrates the reconstruction of image data;

FIG. 19 shows a zoomed printer icon. FIG. 19(a) is an original icon image before encoding, and FIG. 19(b) is a reconstructed icon image after the encoding and decoding of the first embodiment;

FIG. 20 illustrates division of one block of a region 10, indicated by broken lines in FIG. 19, into four regions in a direction Y;

FIG. 21 illustrates a scheme for solving the problem in FIG. 20;

FIG. 22 illustrates an example of division in the primary-axis direction in this embodiment;

FIG. 23 illustrates an example of division in the second color axis direction in this embodiment;

FIG. 24 is a flowchart showing an example of encoding according to a second embodiment;

FIG. 25 illustrates the procedure of step S62 in FIG. 24;

FIG. 26 illustrates the procedure of step S65 in FIG. 24;

FIG. 27 is a flowchart showing an example of encoding according to a third embodiment;

FIG. 28 is a flowchart showing an example of detail of step S75 in FIG. 27;

FIG. 29 illustrates the procedure of step S82 in FIG. 28;

FIG. 30 illustrates division into regions 1 and 2 in a Y-component direction;

FIG. 31 illustrates the second division along the secondary color axis;

FIG. 32 illustrates an example of classifying 16 pixels into regions 1A, 1B, 2A, and 2B;

FIG. 33 illustrates variations in the second division of the regions 1 and 2, respectively;

FIG. 34 is a flowchart showing an example of detail of step S76 in FIG. 27;

FIG. 35 illustrates the relationship between the total number of representative colors and bit accuracy in a value mode;

FIG. 36 illustrates the procedure for four representative colors in the four regions 1A, 1B, 2A, and 2B;

FIG. 37 illustrates an example of data format of coded data in the third embodiment;

FIG. 38 is a flowchart showing an example of decoding in the third embodiment;

FIG. 39 is a flowchart showing an example of detail of step S103 in FIG. 38;

FIG. 40 shows an example of configuration of the ENC 4 in the third embodiment;

FIG. 41 is a flowchart showing an encoding according to a fourth embodiment;

FIG. 42 illustrates the step S126 for three representative colors in total;

FIG. 43 illustrates a data format of coded data in the fourth embodiment;

FIGS. 44(a) and 44(b) illustrate division of one block into groups of three pixels;

FIG. 45 illustrates an example of bit-value adjustments of bitmap data for three representative colors in total;

FIG. 46 illustrates another example of bit-value adjustments of bitmap data for two representative colors in total; and

FIG. 47 illustrates an encoded data format, which has bitmap data compressed by the procedures shown in FIGS. 44 to 46.

### DETAILED DESCRIPTION

Embodiments will now be explained with reference to the accompanying drawings.

In one embodiment, an encoder has a first color sorting unit, a second color sorting unit and an encoding unit. The first color sorting unit divides pixels along a first color axis, each of pixel blocks having a plurality of input pixels, into m regions where m is an integer larger than 2 to classify the plurality of pixels in each of the pixel blocks into the m regions, and to calculate a minimum value, a maximum value and an average value of pixel values belonging to each of the m regions for each of the m regions. The second color sorting unit divides pixels along a second axis selected based on a calculation result of the first color sorting unit, each of the m regions into n sub-regions where n is an integer of two or more, for each of the m regions, to classify the plurality of pixels in the pixel block into (m×n) sub-regions, and to calculate coded information corresponding to representative colors allocated to pixel locations in an original pixel block and bitmap information of the representative colors. The encoding unit generates coded data of the pixel values of the plurality of pixels in the pixel block corresponding to the (m×n) sub-regions based on differences between the representative values corresponding to the representative colors in the (m×n) sub-regions.

### First Embodiment

FIG. shows schematic configuration of a liquid crystal display apparatus using an encoder according to a first embodiment of the present invention.

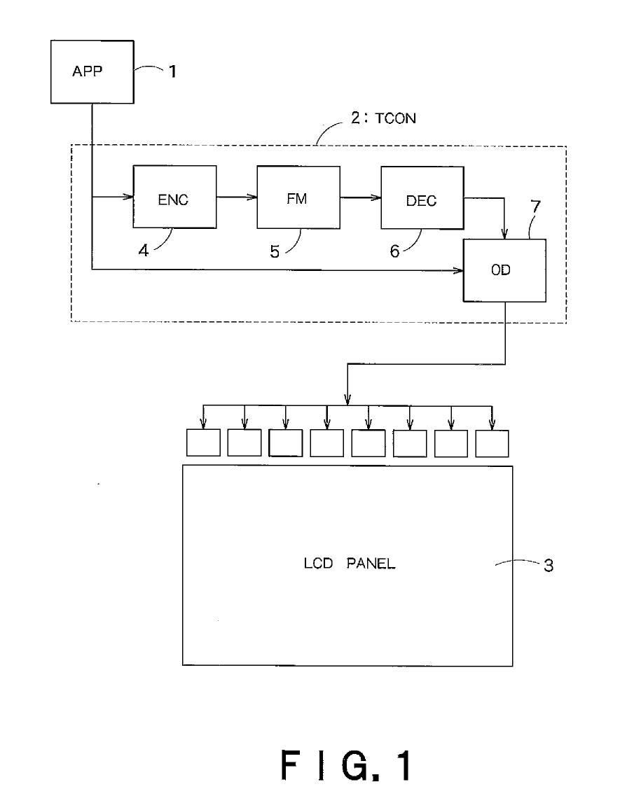

The liquid crystal display apparatus of FIG. 1 is provided with an application processor (APP) 1, a timing controller (TCON) 2, and a liquid crystal panel 3. The TCON 2 includes an encoder (ENC) 4 according to the present embodiment, a frame memory (FM) 5, a decoder (DEC) 6, and an overdrive device (OD) 7.

The APP 1 supplies the TCON 2 with image data to be displayed on the liquid crystal panel 3. The TCON 2 supplies 1-frame image data supplied from the APP 1 to the OD 7, and supplies the data also to the ENC 4 which compresses the data to generate coded data. The coded data is stored in the FM 5. The FM 5 has a storage capacity for at least 1-frame coded data. The coded data is then decoded by the DEC 6 into reconstructed image data.

The OD 7 compares, pixel by pixel, the 1-frame image data supplied from the APP 1 with 1-frame previous image data already stored in the FM 5 and decoded by the DEC 6. The OD 7 controls a gradation voltage when there is a change in pixel values between the compared two frames. By such a control, the overdriven image is always reduced in the both cases: the image data changes or not.

As described above, the coded data generated by ENC 4 according to the present embodiment is not directly used for generating image data to be displayed on the liquid crystal panel 3, but is used for storing the 1-frame previous image data in the FM 5 for the overdrive. Accordingly, a principal objective of the present embodiment is utmost reduction in data amount to be stored in the FM 5 under the condition that image quality is maintained to the extent that the reduction does not obstruct the overdrive function. Our objective is not utmost suppression in image quality degradation.

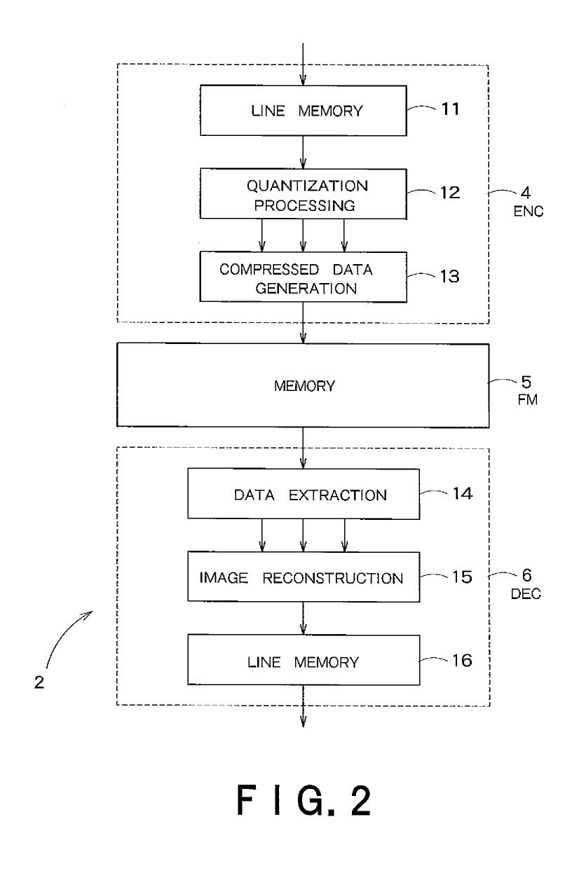

FIG. 2 shows a detailed configuration of the TCON 2. The ENC 4 is provided with a line memory 11, a color quantization unit 12, and a compressed-data generator 13.

The line memory 11 is used for processing the image data block by block. One block is composed of 8×8 pixels in the first embodiment described below. The line memory 11 thus requires storage capacity of image data for eight horizontal lines.

The color quantization unit 12 divides one block into eight regions and classifies 64 pixels of one block into the eight regions, thus calculating representative colors for the respective regions, as described below.

The compressed-data generator 13 generates coded data obtained by compressing the image data of 64 pixels of one block, based on the processing results at the color quantization unit 12, as described below. The generated coded data are stored in the FM 5.

The DEC 6 is provided with a data extractor 14, an image reconstructor 15, and a line memory 16.

The data extractor 14 detects a delimiter between coded data read out from the FM 5. The image reconstructor 15 irreversibly reconstructs representative-color data for each pixel and then generates image data, a pre-quantized reconstructed image data. The color quantization unit 12 performs the quantization process. The image data reconstructed by the image reconstructor 15 is stored in the line memory 16.

The OD7 compares the image data stored in the line memory 16 of the DEC 6 with image data supplied by the APP 1 to determine, pixel by pixel, whether there is image change between the adjacent two frames. Based on the comparison, OD 7 adjusts the gradation voltage.

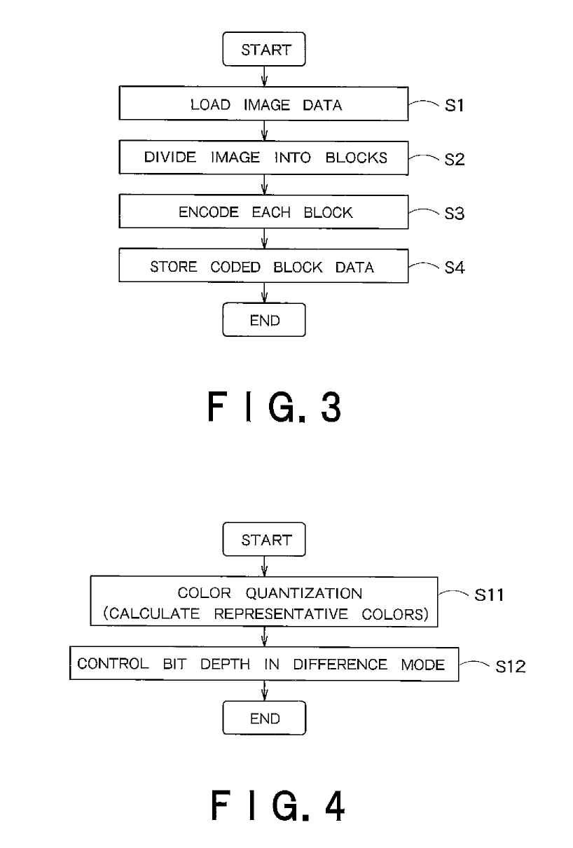

FIG. 3 is a flowchart showing one example of encoding procedure executed by the ENC 4 in FIG. 1. The ENC 4 executes color quantization of image data block by block of 8×8 pixels, for example.

Firstly, the ENC 4 loads the image data supplied from the APP 1 (step S1). The image data to be supplied from the APP 1 may be RGB 3-primary color data, complementary-color data of the primary color data, or luminance and color-difference data Y, Cb and Cr.

The loaded image data is classified by blocks of 8×8 pixels (step S2). The image data is then compressed for each block, to generate coded data (step S3). The generated coded data is stored in the FM 5 (step S4).

FIG. 4 is a flowchart showing an exemplary detailed procedure of step S3 in FIG. 3. Firstly, a block is classified by eight regions and a representative color is calculated for each of the eight regions (step S11). This procedure is called color quantization processing. The present embodiment explains one example having eight representative colors in total. The total number of representative colors is, however, not particularly limited. Moreover, the block size may not necessarily be 8×8 pixels, and arbitrary size is selectable.

The representative colors of the eight regions are compared to one another to set the number of bits for representative values corresponding to the representative colors, depending on differences between the representative values (step S12). This procedure is called bit-depth control. Step S12 corresponds to an encoding means.

Hereinafter, we are going to explain an example in which image data prior to coding is color-difference data of color-difference Y, Cb and Cr, each having 10-bit accuracy.

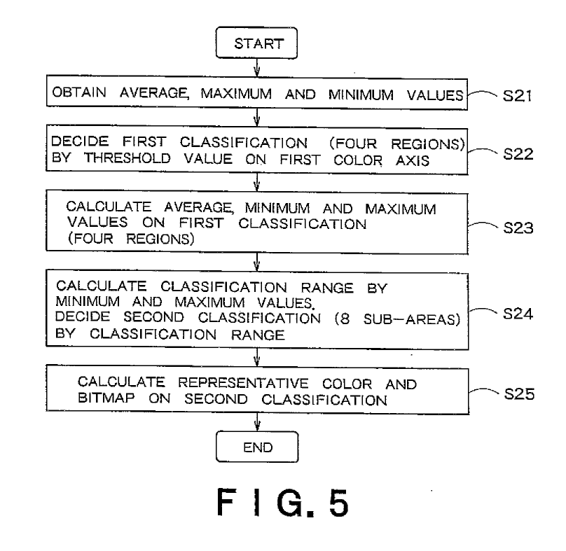

FIG. 5 is a flowchart showing one example of a detailed procedure of step S11 in FIG. 4.

Firstly, the average value, the maximum value, and the minimum value are detected per pixel in a block for each color component (step S21). Color components may be RGB components, complementary-color components thereof, or luminance and color-difference components Y, Cb and Cr. We are going to explain an example in which image data prior to coding is color-difference data of luminance and color-difference data Y, Cb and Cr, each having 10-bit accuracy.

Next, a first color axis for classifying the block by four regions is decided based on the results of step S21. More specifically, the following equations (1) to (3) are used to detect spread of the components Y, Cb, and Cr:

Y-component spread=Y-maximum value−Y-minimum value (1)

Cb-component spread=Cb-maximum value−Cb-minimum value (2)

Cr-component spread=Cr-maximum value−Cr-minimum value (3)

A selected first color axis is a color axis with the maximum spread in the spread of the color components. Next, three threshold values are set on the selected first color axis, in order to classify 64=8×8 pixels of a block by the four regions (step S22).

Steps S21 to S23, and Steps S24 and S25, shown in FIG. 5, correspond to a first color clustering means and a second color clustering means, respectively.

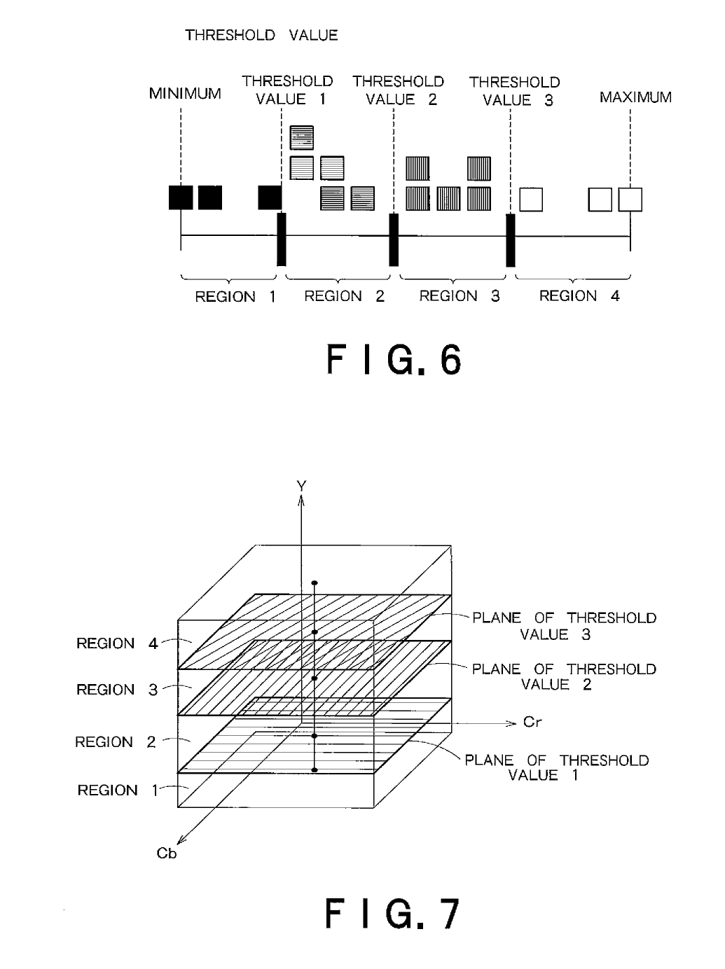

FIG. 6 illustrates threshold values 1 to 3 set on the first color axis.

The threshold values 1 to 3 are calculated from the following equations (4) to (6):

Threshold value 1=(minimum value+average value)/2 (4)

Threshold value 2=average value (5)

Threshold value 3=(average value+maximum value)/2 (6)

The threshold-values 1 to 3 are truncated by, for example, round-off subject to bit accuracy. The truncation is a mid-tread type, for example. The following regions 1 to 4 are then obtained by using the threshold values 1 to 3:

Minimum value≦region 1<threshold value 1 (7)

Threshold value 1≦region 2<threshold value 2 (8)

Threshold value 2≦region 3<threshold value 3 (9)

Threshold value 3≦region 4<maximum value (10)

The boundary values between the regions 1 to 4 and the threshold values 1 to 3 may not necessarily satisfy the relationships (7) to (10). The boundary values may satisfy the following relationships (11) to (14), for another example:

Minimum value<region 1≦threshold value 1 (11)

Threshold value 1<region 2≦threshold value 2 (12)

Threshold value 2<region 3≦threshold value 3 (13)

Threshold value 3<region 4≦maximum value (14)

FIG. 7 shows an example in which a block is classified by four regions along a Y-axis as the first color axis. In this case, a plane of threshold value 1, a plane of threshold value 2, and a plane of threshold value 3 are provided along the Y-axis. The regions 1 to 4 are made perpendicular to the Y-axis direction with the three planes as borders.

Next, the average value, the maximum value, and the minimum value of pixels belonging to each of the four regions 1 to 4 classified along the first color axis is detected for each of the regions 1 to 4 (step S23). The detection procedure is performed for each of the color components Y, Cb, and Cr.

For example, for the region 1 in FIG. 7, the average value, the maximum value, and the minimum value are detected by the following procedure:

Y-minimum value of region 1=minimum value of component Y in pixel data belonging to region 1);

Y-average value of region 1=average value of component Y in pixel data belonging to region 1;

Y-maximum value of region 1=maximum value of component Y in pixel data belonging to region 1;

Cb-minimum value of region 1=minimum value of component Cb in pixel data belonging to region 1;

Cb-average value of region 1=average value of component Cb in pixel data belonging to region 1;

Cb-maximum value of region 1=maximum value of component Cb in pixel data belonging to region 1;

Cr-minimum value of region 1=minimum value of component Cr in pixel data belonging to region 1;

Cr-average value of region 1=average value of component Cr in pixel data belonging to region 1; and

Cr-maximum value of region 1=maximum value of component Cr in pixel data belonging to region 1.

The detection procedure for the region 1 is also performed for the regions 2 to 4.

Next, color-component-wisely calculate a difference between the maximum and minimum values color for each of the regions 1 to 4. Select the color axis which has the largest difference of color component, and use the axis as second color axis for a second classification (step S24).

In step S24, using the following equations (15) to (17), calculate the spreads of the components Y, Cb, and Cr:

Y-component spread=Y-maximum value−Y-minimum value (15);

Cb-component spread=Cb-maximum value−Cb-minimum value (16)

Cr-component spread=Cr-maximum value−Cr-minimum value (17)

Among the color components, find a color component having the largest spread among the equations (15) to (17), in order to decide as the second color axis direction for the second division. This procedure is executed for each of the regions 1 to 4.

Average values and secondary moments may be used to detect the spread instead of calculating the difference between the maximum and minimum values.

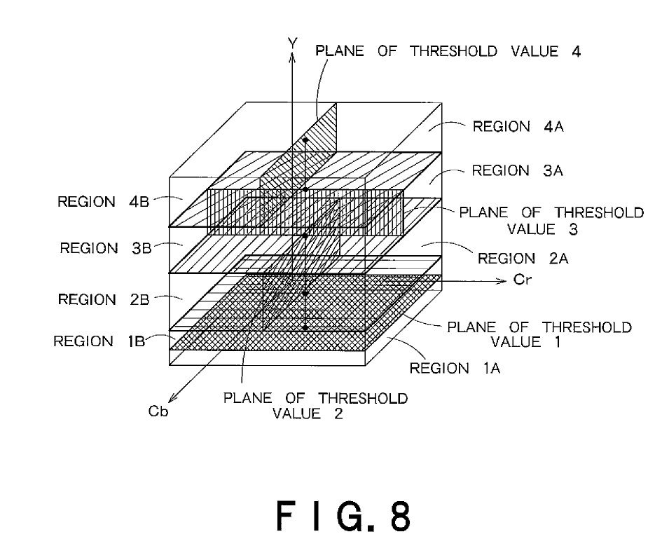

FIG. 8 illustrates the second division. In FIG. 8, the regions obtained by classifying each of the regions 1 to 4 into two are distinguished each other by “A” and “B”. In detail, in FIG. 8: the region 1 is classified into two in the Y-axis direction to make regions 1A and 1B; the region 2 is classified into two in a direction Cr to make regions 2A and 2B; the region 3 is classified into two in a direction Cb to make regions 3A and 3B; and the region 4 is classified into two in the direction Cr to make regions 4A and 4B. Accordingly, one block is classified into 8=4×2 regions in total by the second classification.

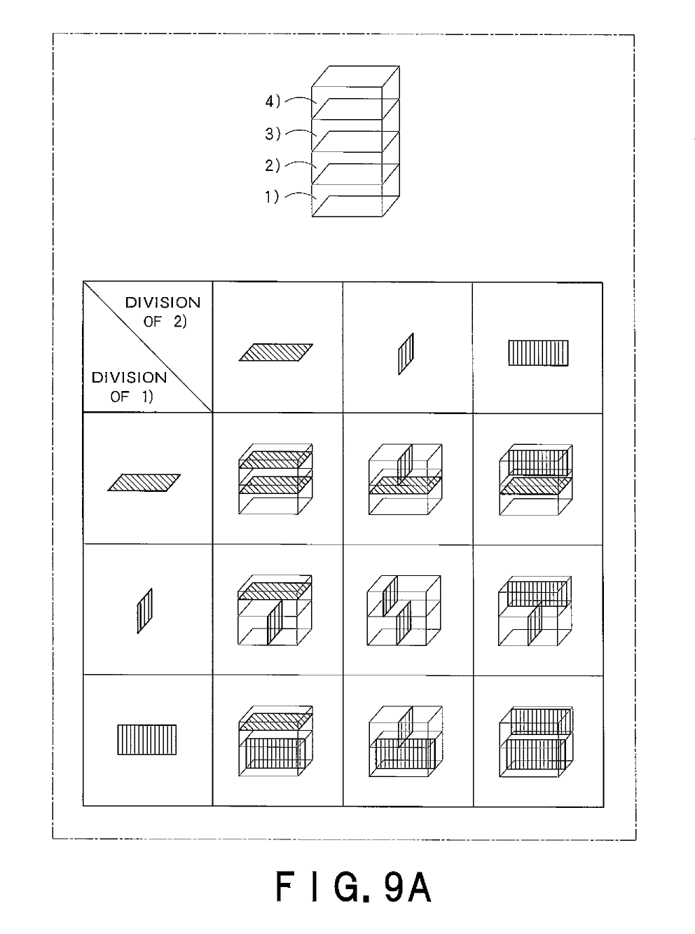

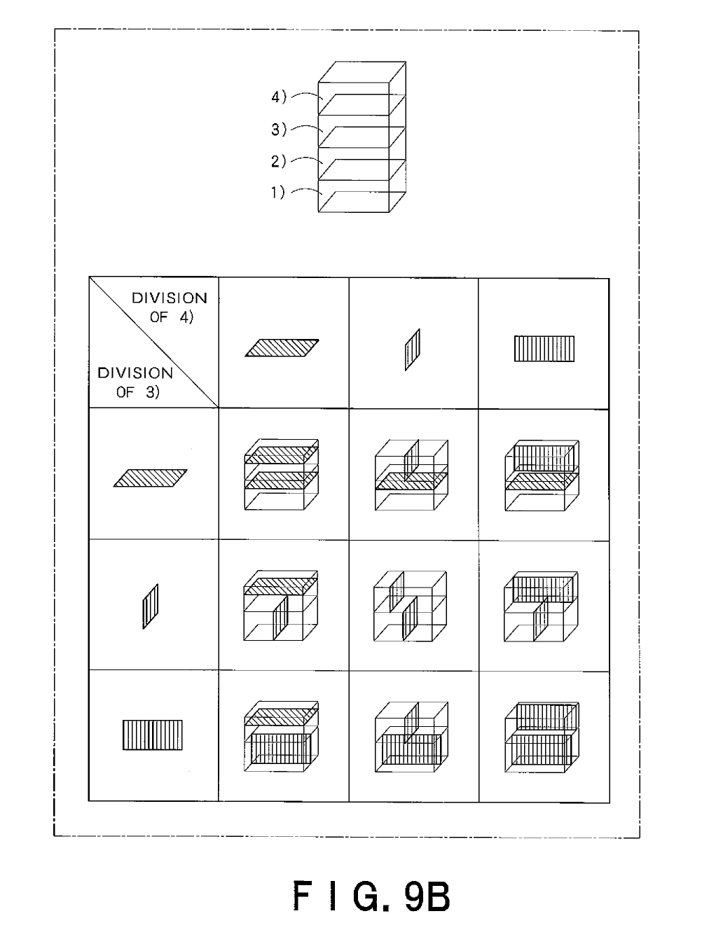

The second classification is performed along one of three directions Y, Cb, and Cr for each of the regions 1 to 4. FIG. 9A illustrates all candidates in classification for the regions 1 and 2. FIG. 9B illustrates all candidates in classification for the regions 3 and 4. As shown in FIG. 9A, the regions 1 and 2 have 9=3×3 combinations of classification. Also shown in FIG. 9B, the regions 3 and 4 have 9=3×3 combinations of classification. Thus, there are 81=9×9 combinations of classification for the entire regions 1 to 4. FIG. 8 illustrates one of the 81 combinations of classification.

When the step S24 in FIG. 5 sets the second color axis direction for the second classification, decide a representative color and generate bitmap data for each of the eight regions obtained in the second division (step S25). In step S25, calculate an average value of pixel values for each color component belonging to each of eight regions. The average value is calculated for each of the luminance and color-difference components Y, Cb and Cr. As the calculated three average values represent a color vector, use them as representative values of a representative color. Thus, representative color is set for each of the eight regions.

Also in step S25, generate bitmap data for each of 64=8×8 pixels in one block. The bitmap data shows color indices of the eight regions each pixel belongs to. That is, the bitmap data represents each of the 64=8×8 pixels with a representative color of one of the eight regions. Three-bit data is enough for the eight regions to identify the representative color of each region. A pixel belonging to the region 1A in FIG. 8 is given 0H(000), for example.

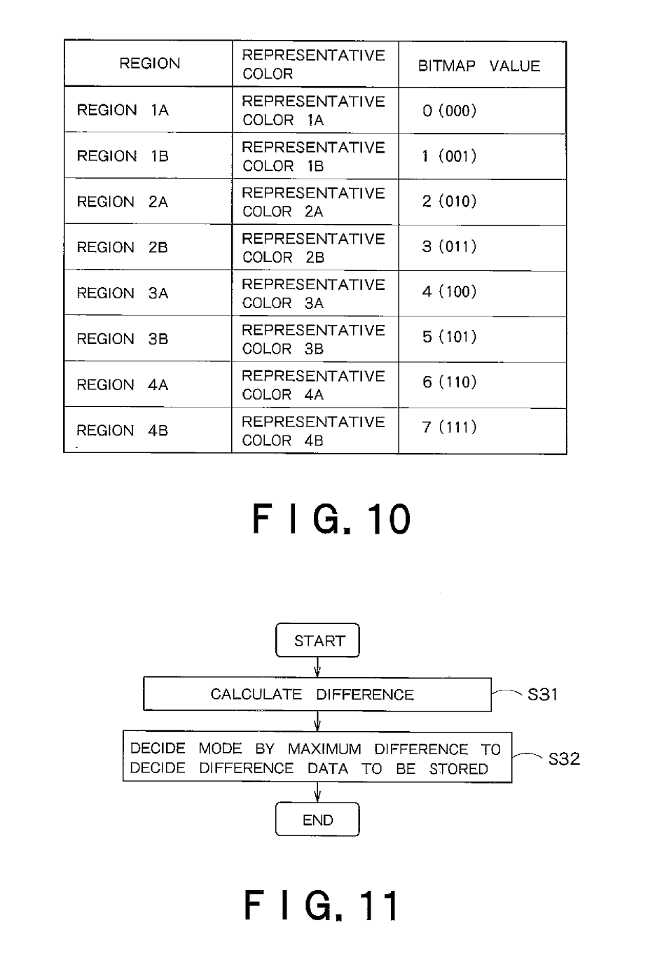

FIG. 10 shows an example of the bitmap data. In FIG. 10, allocate 3-bit bitmap values of 0 to 7 regions to the eight regions 1A to 4B. Representative colors 1A to 4B corresponding to the regions 1A to 4B, respectively, are color vectors each having the average value of the color components of a pixel belonging to each region. Each of the representative colors 1A to 4B is a color vector of a representative color made up of the three color components Y, Cb, and Cr.

By using the bitmap data in FIG. 10, replace each of the 64 (=8×8) pixels in one block by a corresponding representative color selected in one from the eight regions, where performing color quantization.

Among the eight regions in FIG. 10, preferably give a default value for a region with no pixel data, without unnecessary calculation of average value. Default value is preferable because it is suitable to set a proper value for such a region with no pixel data when the encoding procedure is implemented by hardware in this embodiment. Nevertheless, in the region with no pixel data, there is no chance where the corresponding bitmap data is utilized, and therefore the calculation is unnecessary for referring to the representative color.

Hereinafter, the bit-depth control of step S12 in FIG. 4 will be explained more specifically. FIG. 11 is a flowchart showing an example of detailed procedure of step S12 in FIG. 4. Firstly, calculate a difference between the representative values of the eight regions in one block for each color component (step S31). Then, decide a difference mode for each color component, according to the maximum value calculated in step S31 in order to decide a bit format for difference data to be stored (step S32).

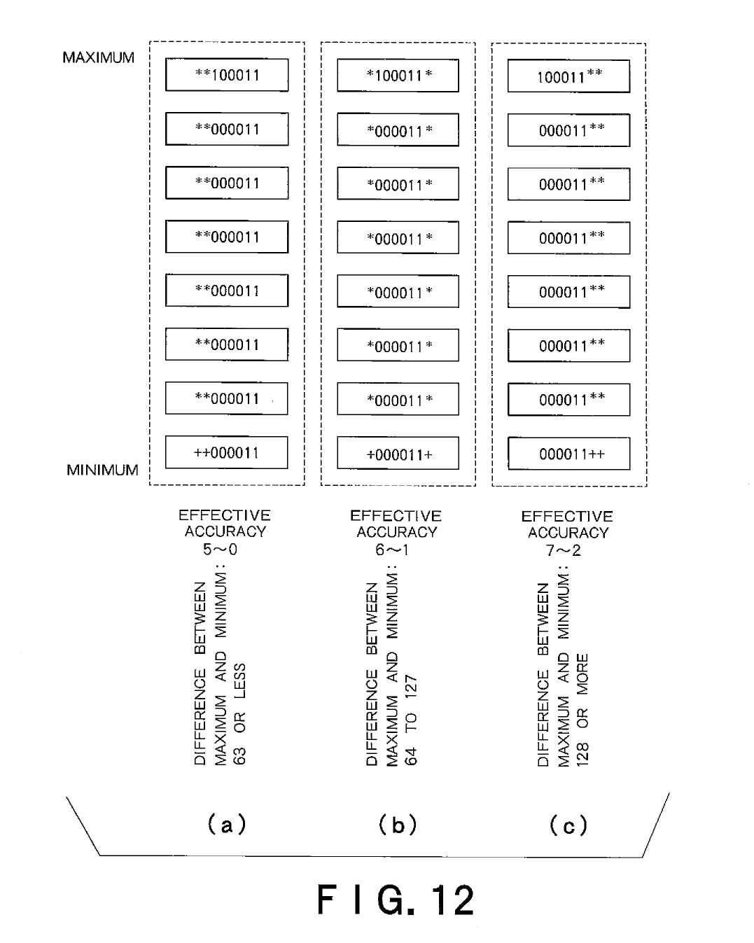

FIG. 12 shows a difference mode for the component Y. In detail, FIG. 12 shows the data formats: representative values of the component Y in the eight regions in one block are sorted from the minimum to maximum values. FIG. 12(a) shows an example where a difference between the maximum and minimum values is 63 or less. FIG. 12(b) shows an example where the difference is 64 or more but 127 or less. Finally, FIG. 12(c) shows an example where the difference is 128 or more.

Suppose that the representative value of the component Y in the region 2A is the minimum value. In this case, calculate the value for the difference between the representative value of the component Y in the region 2A and that of the component Y in each of the other regions, by the following equations (18) to (25):

Y-difference in region 1A=Y-representative value in region 1A−Y-representative value in region 2A (18)

Y-difference in region 1B=Y-representative value in region 1B−Y-representative value in region 2A (19)

Y-difference in region 2A=Y-representative value in region 2A−Y-representative value in region 2A (20)

Y-difference in region 2B=Y-representative value in region 2B−Y-representative value in region 2A (21)

Y-difference in region 3A=Y-representative value in region 3A−Y-representative value in region 2A (22)

Y-difference in region 3B=Y-representative value in region 3B−Y-representative value in region 2A (23)

Y-difference in region 4A=Y-representative value in region 4A−Y-representative value in region 2A (24)

Y-difference in region 4B=Y-representative value in region 4B−Y-representative value in region 2A (25)

The Y-representative value in the formula (20) is zero for the region 2A. The Y-representative values for the other regions thus take a value of a positive value (including zero).

It is noted that the difference discussed here means the difference between two representative values of regions. In general, a term “difference” means a difference between a representative value and an average value in most cases. An average value is generally not expected to be equal to a representative value of a region. In the case of storing both average and difference values, average is stored excessively compared with the present embodiment. The present embodiment adopts an approach with less amount of data (“a minimum-value supplemental bit” or “a minimum-indicating bit”, as described later), in order to reduce the amount of data to the utmost extent.

In step S31 of FIG. 11, select quantization mode subject to the difference between the maximum and minimum values in the eight regions. More specifically, in the case of flat images with a few image changes, enhance accuracy (bit-depth of stored bits) to improve image quality. On the other hand, in the bumpy case of images where many image changes, accept lower image accuracy, because human cannot visually discriminate fine pixel changes in the bumpy image texture. Thus, adaptive quantization is adopted depending on the difference.

All of difference values are given by six bits when the difference between the maximum and minimum values is 63 or less. Assume that the representative values of the representative colors are given at 8-bit accuracy in order to simplify explanation of this embodiment. In order to ensure 8-bit accuracy, the minimum-value data must be given by eight bits. For the regions that has the minimum value (for the region 2A in the description above, for instance), it is not necessary to store difference data, because the difference always equals to zero. Instead of storing “zero”, it is necessary to store the minimum value itself. For this reason, additional two bits region to the six bits for storing the difference value of the region 2A to acquire an 8-bit accuracy region for storing the minimum value itself. The added two bits are referred to “minimum-supplemental bits” in this embodiment.

In the above, an example has been explained under the assumption that the region 2A has the minimum value. In other assumption, one of the other seven regions may have the minimum value. For this reason, three bits are required to indicate which region has the minimum value. These three bits region referred to “minimum-indicating bits”. A sign “*” in FIG. 12 indicates that eight bits are obtained by adding the minimum value to the six bits of difference. Moreover, a sign “+” in FIG. 12 indicates minimum-value supplemental bits to be added to the six bits of the minimum value.

Set up the accuracy up to 7-bit depth when the difference between the maximum and minimum values is 64 or more but 127 or less. The difference value has six bits, but does not have a bit corresponding to an LSB.

Set up the accuracy up to 6-bit depth for the difference of 128 or more between the maximum and minimum values. The difference value of six bits at the accuracy of 6-bit depth has no bits corresponding to LSB-side two bits.

Such cases described above region referred to “quantization mode” in this embodiment. The value of the mode is stored as quantization mode flag.

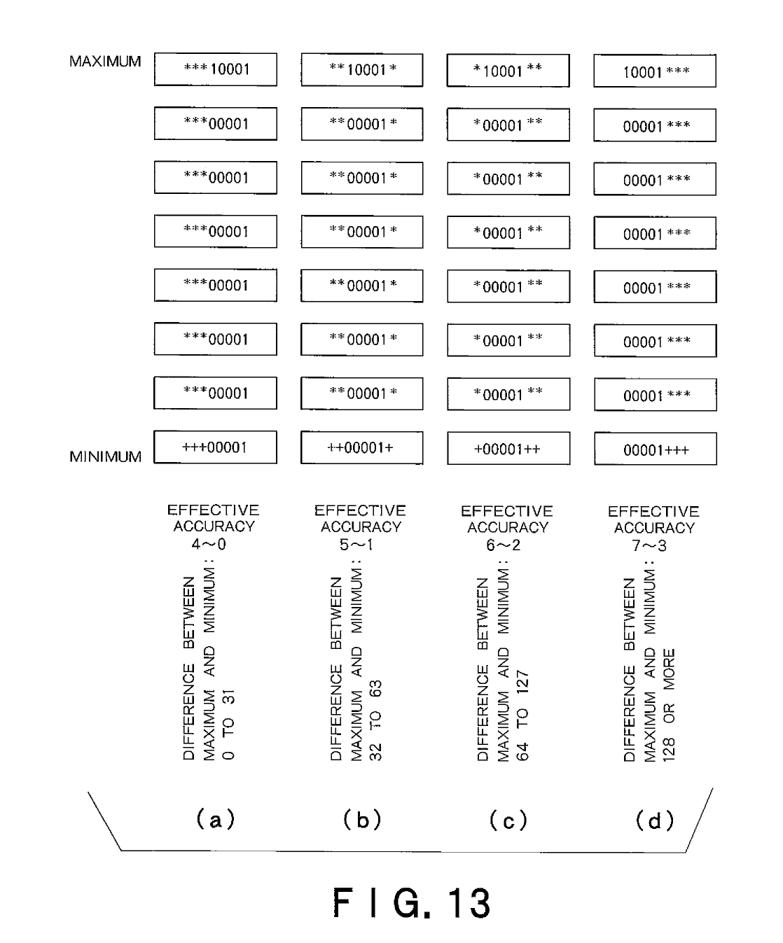

FIG. 12 illustrates the difference mode for the component Y. The same procedure is also performed for the components Cb and Cr. FIG. 13 illustrates difference modes for the components Cb and Cr. There are four difference modes, as shown in FIGS. 13(a), 13(b), 13(c) and 13(d), because we choose to use five bits of the difference value for the components Cb and Cr. In the difference modes for the components Cb and Cr, the minimum-value supplemental bits have three bits for the minimum value represented by eight bits, like as the component Y. The minimum-indicating bits have three bits, like as the component Y, because representative colors are eight.

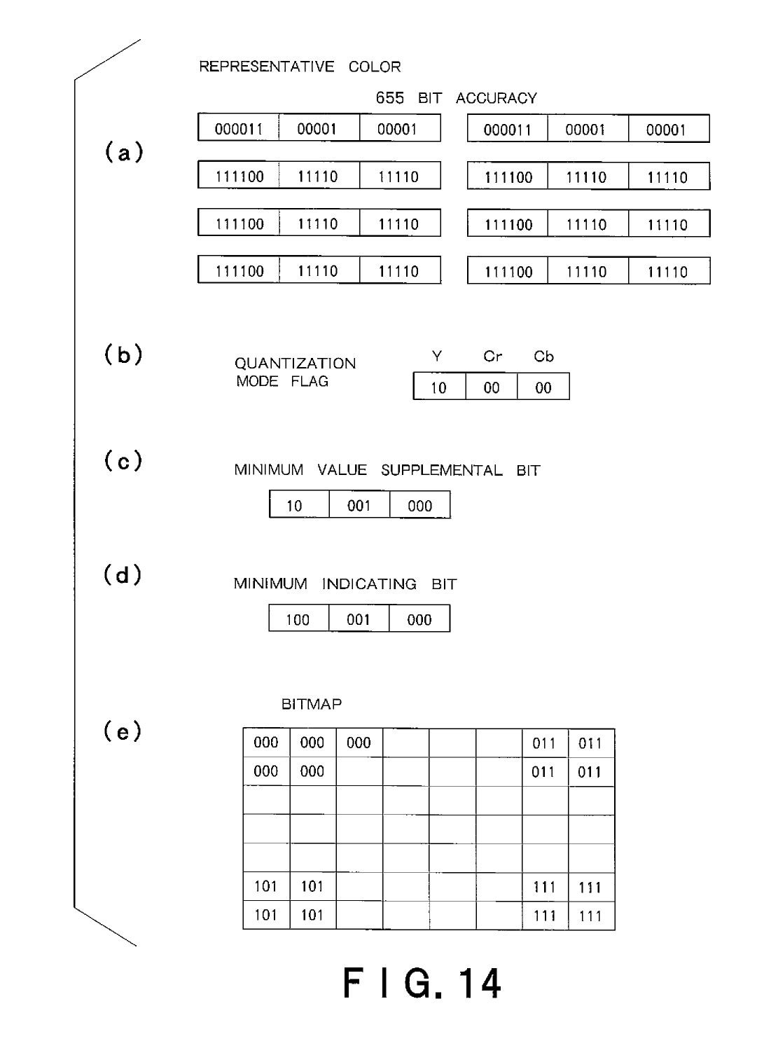

FIG. 14 illustrates data included in encoded data generated by the ENC 4. FIG. 14 shows data necessary for encoding 1-block image data.

Encode one block by using the classification of eight regions. To each region, allocate followings: a 6-bit representative value of the Y-component representative color, a 5-bit representative value of the Cb-component representative color, and a 5-bit representative value of the Cr-component representative color region. Then encode the entire one block by eight representative colors, and therefore, it requires 128 (=(6+5+5)×8) bits, as shown in FIG. 14(a).

Encoded data has a 2-bit quantization-mode flag for each of the components Y, Cb, and Cr. The quantization-mode flags are provided block by block, and hence require 6=2+2+2 bits, as shown in FIG. 14(b).

Encoded data has minimum-value supplemental bits for each of the components Y, Cb, and Cr. As required minimum-value supplemental bits, we have two bits for the component Y and three bits for each of the components Cb and Cr. Thus, one block requires 8=2+3+3 bits, as shown in FIG. 14(c).

Encoded data has minimum-indicating bits for each of the components Y, Cb, and Cr. The minimum-indicating bits are three bits for each component, as shown in FIG. 14(d). Thus, the minimum-indicating bits for one block require 9=(3+3+3) bits.

Moreover, encoded data has bitmap data that indicates to which of the eight regions each of 64=8×8 pixels in one block belongs. As shown in FIG. 14(e), three bits are necessary for identifying one from the eight regions. Thus, the bitmap data for one block requires 192=3×64 bits.

As described above, the entire encoded data requires 343 (=128+6+8+9+192) bits. In contrast, original image data of non-encoding has 10 bits for each color component, and hence has 1920 (=(10+10+10)×8×8) bits in total. The compression rate is thus 5.6=1920/343.

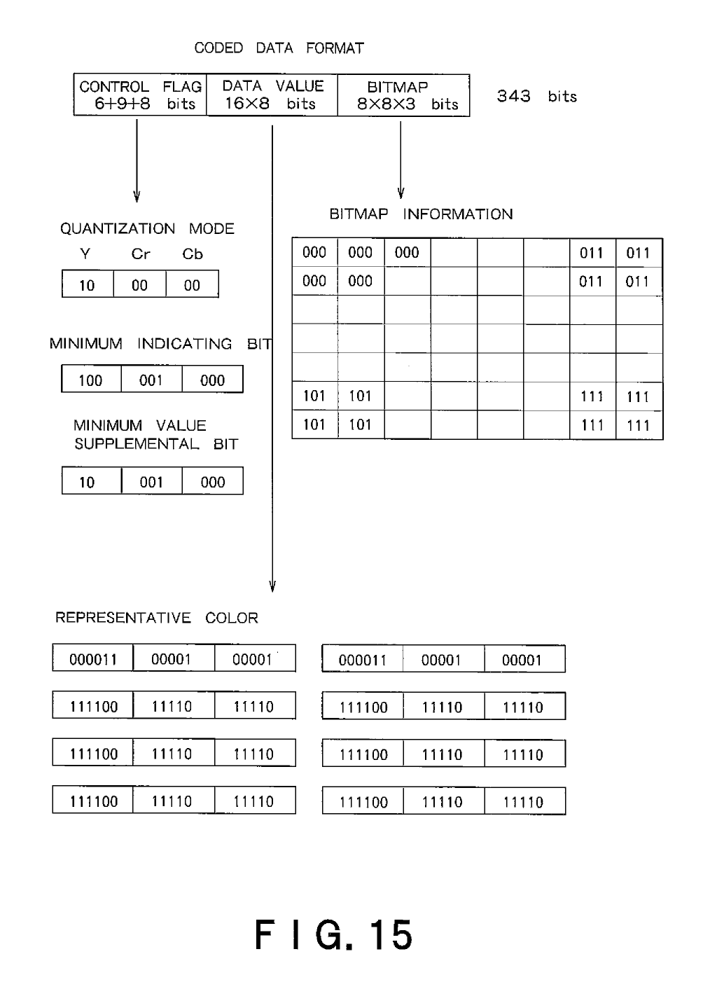

FIG. 15 shows an example of encoded data format. As shown, encoded data has a control flag, representative-value data, and bitmap data. The control flag includes the quantization-mode flag, the minimum-indicating bits, and the minimum-value supplemental bits, which have been explained in FIG. 14, and has 23 (=6+9+8) bits in total. The representative-value data is data for each color component in each of the eight regions explained in FIG. 14, and has 128 (=(6+5+5)×8) bits in total. The bitmap data is the data explained in FIG. 14, and has 192 (=3×64) bits in total.

The encoded data format may not be necessarily restricted to the one shown in FIG. 15, which may be modified subject to the configuration of the FM 5.

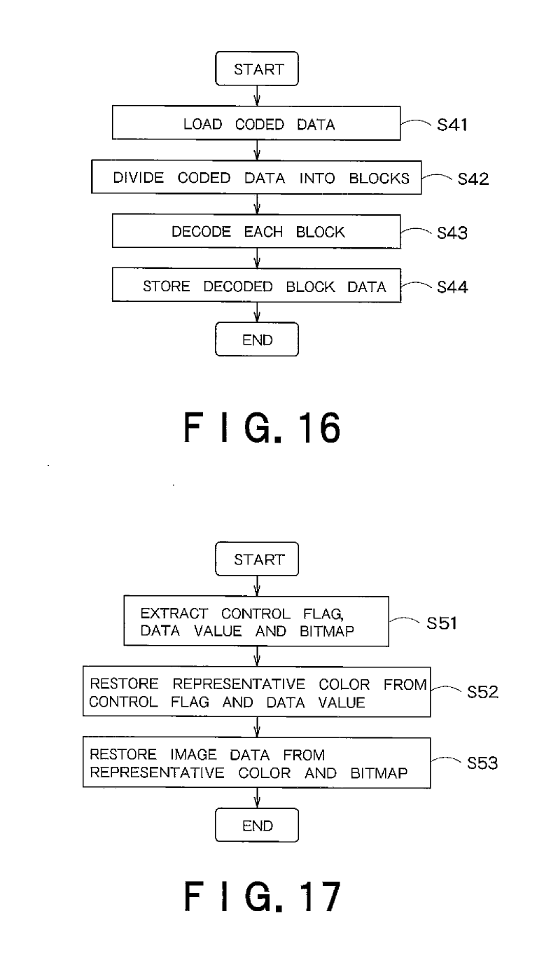

A decoding method will be explained hereinafter in order to decode encoded data with the data format shown in FIG. 15. FIG. 16 is a flowchart showing an example of decoding procedure executed by the DEC 6 in FIG. 1. The DEC 6 reads out encoded data stored in the FM 5 (step S41). Classify the encoded data into blocks (step S42). The encoded data are processed block by block. Decode them to reconstruct representative-color data for each pixel (step S43). Store the reconstructed data in a memory (not shown) (step S44).

FIG. 17 is a flowchart showing an example of detailed procedure of step S43 in FIG. 16. Firstly, extract the followings: a control flag, representative-value data, and bitmap data from the block-by-block coded data (step S51).

Then, reconstruct representative colors by using the control flag and the representative-value data. This is done by a reverse procedure of the encoding procedure explained in FIGS. 12 to 14. More specifically, by using the minimum-indicating bits, determine which representative color has the minimum value. Since the minimum-indicating bits are set for each color component, detect a representative color corresponding to the minimum value, for each color component.

Hereinafter, the procedure of the component Y will be explained for simplicity. Suppose the case that a representative color 2A takes the minimum value for the color component Y. Add the minimum-value supplemental bits of 2 bits to LSB-side bits of the representative-value data of 6 bits of the region 2A corresponding to the representative color 2A. Thus we reconstruct the minimum value with 8-bit accuracy.

Detect a quantization flag for the component Y in order to decide the accuracy of each difference. Select the quantization modes in FIGS. 12(a), 12(b) and 12(c) subject to the detected quantization flags: 00, 01, and 10, respectively.

When the quantization mode in FIG. 12(a) is selected, reconstruct the representative values of the seven regions, except for the region 2A that corresponds to the minimum value, subject to the following equations:

Representative value in region 1A=Y-difference data 1A+Y-data of 8-bit reconstructed minimum value

Representative value in region 1B=Y-difference data 1B+Y-data of 8-bit reconstructed minimum value

Representative value in region 2B=Y-difference data 2B+Y-data of 8-bit reconstructed minimum value

Representative value in region 3A=Y-difference data 3A+Y-data of 8-bit reconstructed minimum value

Representative value in region 3B=Y-difference data 3B+Y-data of 8-bit reconstructed minimum value

Representative value in region 4A=Y-difference data 4A+Y-data of 8-bit reconstructed minimum value

Representative value in region 4B=Y-difference data 4B+Y-data of 8-bit reconstructed minimum value

The same procedure is executed for the data Cb and Cr.

Reconstruct image by means of the reconstructed representative values and bitmap data (step S53). This is a reverse procedure of step S25 in FIG. 5. Replace block-by-block the color of each pixel with the representative color in the encoding procedure, and therefore, the color of each pixel reconstructed in step S53 is the representative color.

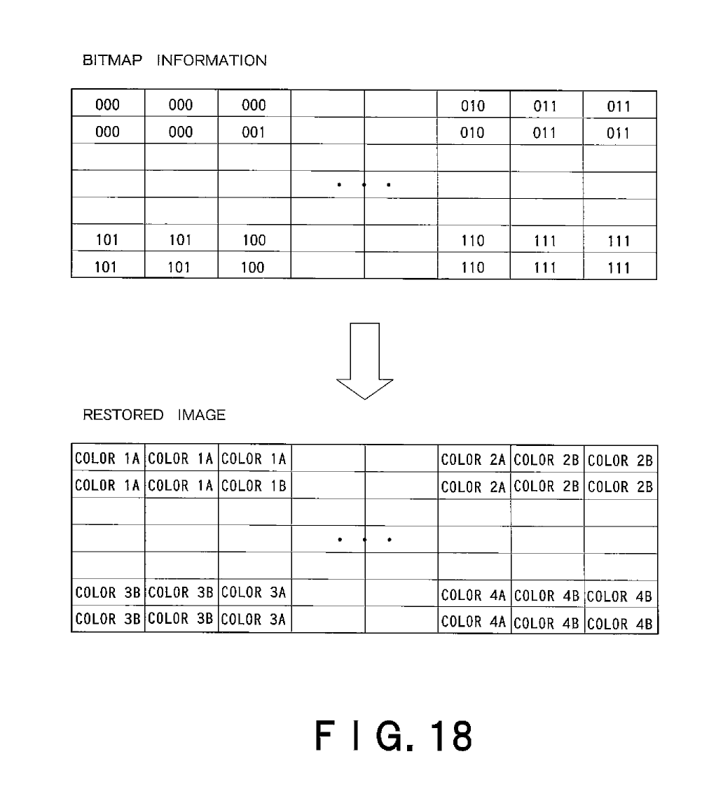

FIG. 18 illustrates the reconstruction of image data. In FIG. 18, for 64 pixels in one block, each bitmap data is composed of 3-bit data which indicates one of eight representative colors. Thus, each pixel is replaced with indicated color selected from the eight representative colors, and therefore, the color for each pixel reconstructed in step S53 is replaced by the indicated representative color.

As described above, in the first embodiment, one block composed of 64 pixels is classified by four regions in the first color axis direction. The pixels are then classified into the four regions. Each region is classified in the second color axis direction, in order to classify one block into eight regions. The pixels are then classified into the eight regions. A representative color is set for each region. A difference between the representative values of the representative colors of the region is calculated to decide a quantization mode. Encoded data having the data format shown in FIG. 14 is then generated based on the quantization mode and the representative values. According to the first embodiment, an encoding procedure can be executed at high compression rate with relatively less degradation of image quality of original images.

The encoding procedure in the first embodiment may also be used to store 1-frame previous image data in the FM 5 for overdrive. According to the present embodiment, it reduces the storage capacity of the FM5, and hence reduces hardware complexity.

The above-described first embodiment shows an example in which one block is composed of 8×8 pixels, the first classification classifies one block into four regions in the first color axis direction and the second classification classifies each the four regions into two in the second color axis direction. The number of pixels in one block and the number of regions in the first and second classification are, however, may be adjusted. The first embodiment is then generalized as follows.

Each of input pixel blocks each having a plurality of pixels is classified into “m” regions where m is an integer of 2 or more, along the first color axis direction. The pixels in each pixel block are then classified into the “m” regions, and the minimum, maximum and average values of pixel values belonging to each region are calculated for each of the “m” regions. The procedure is performed by a first color sorting unit.

Each of the “m” regions is classified into “n” sub-regions where n is an integer of 2 or more, along the second color axis direction selected based on the calculation by the first color sorting unit. The pixels in each pixel block are then classified into an “m×n” sub-regions, and coded information corresponding to representative colors allocated to pixel locations in an original pixel block and bitmap data on the representative colors are calculated for each of “m×n” sub-regions. This procedure is performed by a second color sorting unit.

Then, encoded data is generated by encoding the pixel values of a plurality of pixels in a pixel block corresponding to the “m×n” sub-regions, based on differences between the representative values corresponding to the representative colors of the respective “m×n” sub-regions.

### Second Embodiment

In the first embodiment, one example has been explained for aiming for generating 1-frame previous encoded data for overdrive. The encoded data generated in the first embodiment may also be used for display purpose. For this purpose, however, the first embodiment has a problem that it is impossible to accurately reconstruct colors of the pixels, because pixels in one block are replaced color component by color-component with representative colors selected from among eight colors. Furthermore, the present inventor found another problem occurred when we use the encoded data generated by the first embodiment for display purpose. This problem will be discussed below.

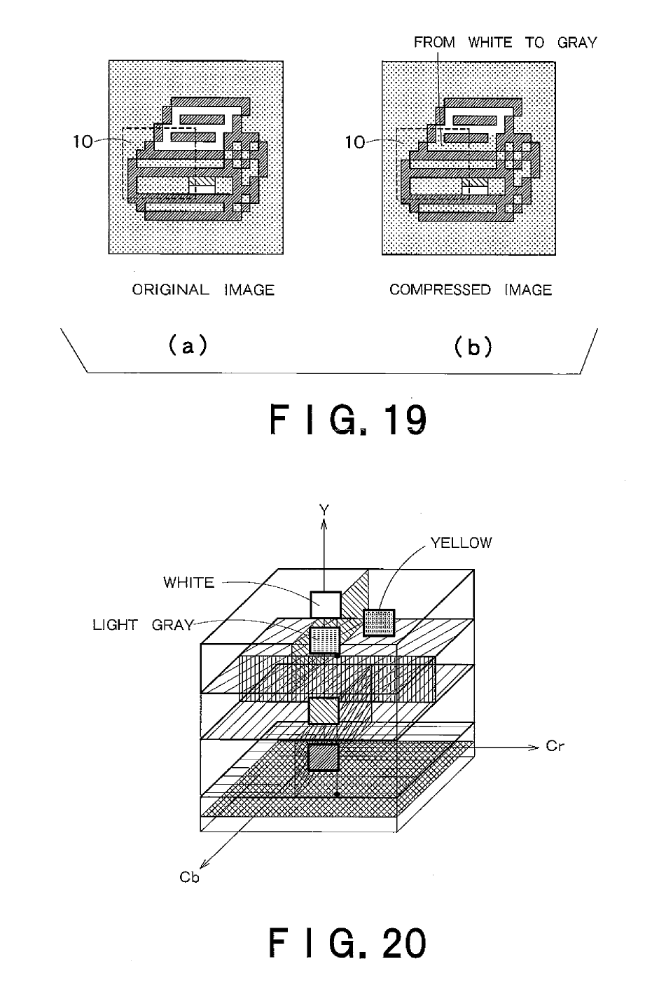

FIG. 19 is a zoomed printer icon. In detail, FIG. 19(a) is an original icon before encoding of the first embodiment. FIG. 19(b) is a reconstructed icon after decoding of the first embodiment.

As shown in FIG. 19, in the printer icon, some white pixels (of originally expressing a paper) are replaced by gray pixels. This is because the color pixels (white of the paper and gray of background and a printer itself) are merged as the processing result, and they are classified to the same classification-region, which causes a mixture of the colors, which forms a representative color of lighter gray.

The second embodiment to be described below is presented to solve such problem discussed above.

In FIG. 19, a region 10, surrounded by broken lines, represents one block (64 pixels) as processing unit. FIG. 20 illustrates an example to classify this block of the region 10 shown by the broken lines in FIG. 19, into four regions along a direction Y. This single block has five colors: white, yellow, light gray, dark gray, and black. Each color is represented by a rectangle filled with its color in FIG. 20. Among the five colors, the pixels with white, yellow, and light gray are simultaneously classified into a region 4, because the component Y of yellow and light gray is very close to that of white.

The first embodiment classifies one block into four regions along the first color axis (an axis Y, for example) direction and then further classifies each pixel into two regions. So, three colors of the region 4 are classified into the two regions 4A and 4B: yellow is classified to the region 4A and white and light gray is classified to the region 4B, for example. As a result, white and light gray are averaged as a representative color for the region 4B. This gives the final result that original white and light gray are mixed, and the mixed color is visually detected.

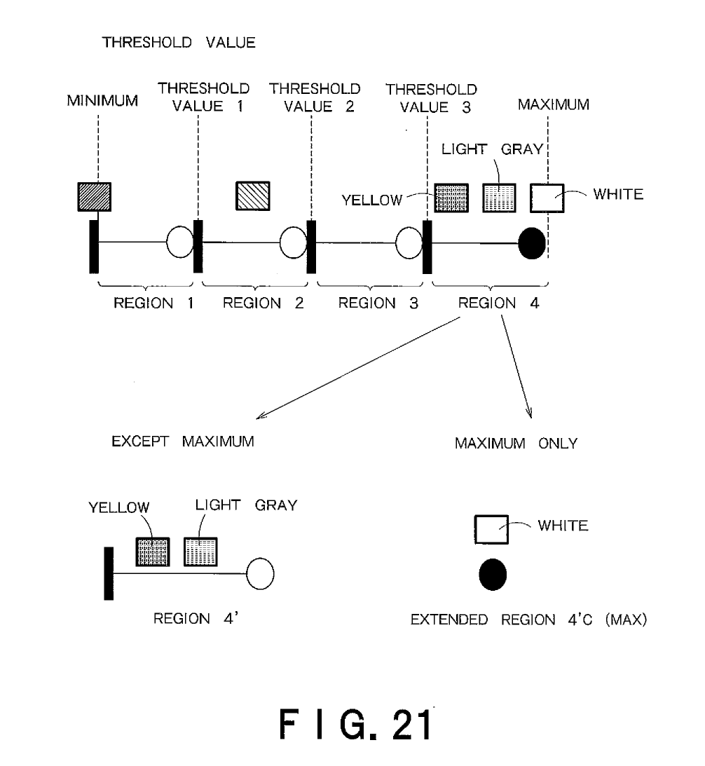

FIG. 21 illustrates a scheme for solving the problem in FIG. 20

As shown in FIG. 21, when classifying one block into four regions in a Y-component direction, white, light gray, and yellow are allocated to a region 4, where this region 4 spans between the maximum value and a threshold value 3 in the Y-component direction. In this scheme, the region 4 is classified further into two regions newly generated: (1) a new region (an extended region 4′C, hereinafter) to which white (the maximum of Y component) belongs and (2) another new region (a region 4′, hereinafter) to which light gray and yellow belong. Such generation of new regions prevents the problem that white mixes with another color.

FIG. 22 illustrates a classification example along the first color axis direction in this embodiment. FIG. 22 shows classification along the Y-component direction. The first embodiment classifies one color into four regions along the first color axis direction. On the other hand, this other embodiment classifies one block into four regions, and then further classifies a region 4 into an extended region 4′C and a region 4′. Thus 5=4+1 regions are generated along the first color axis direction.

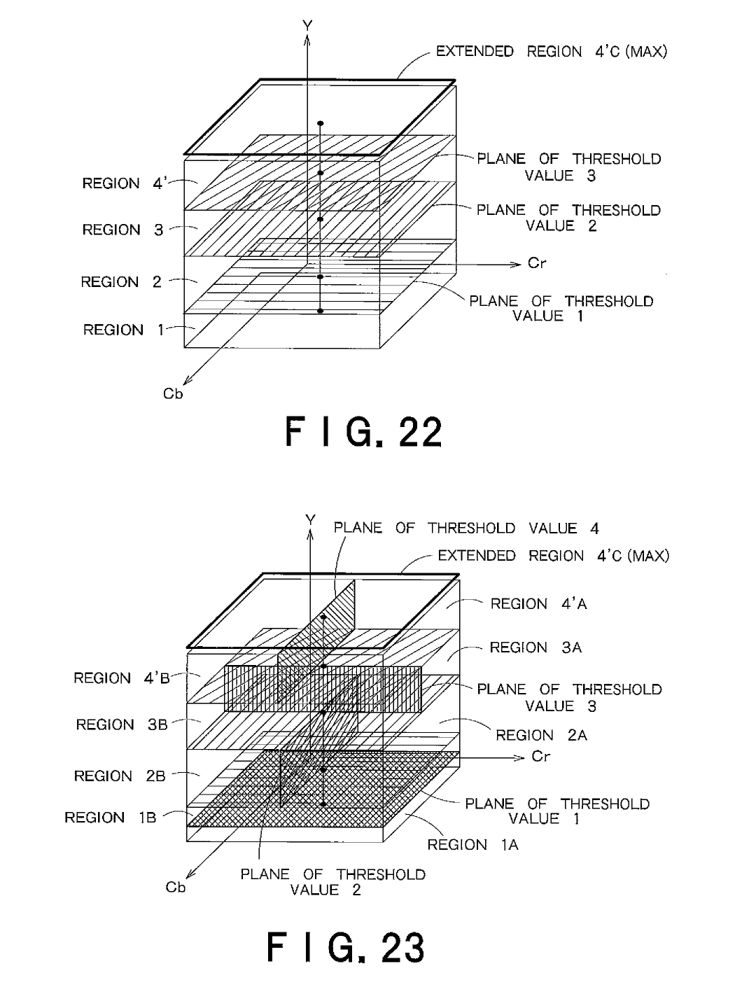

FIG. 23 illustrates a classification example along the second color axis direction in this embodiment. In this case, the extended region 4′C obtained in the classification in the first color axis direction is not classified further into two, but each of the other regions 1 to 3 and the region 4′ are classified further into two. In this classification, yellow and light gray belonging to the region 4′ in FIG. 21 are allocated to different regions 4′A and 4′B. For example, yellow is allocated to region 4′A, and light gray is allocated to the region 4′B. This avoids color-change from an actual color due to color mixture.

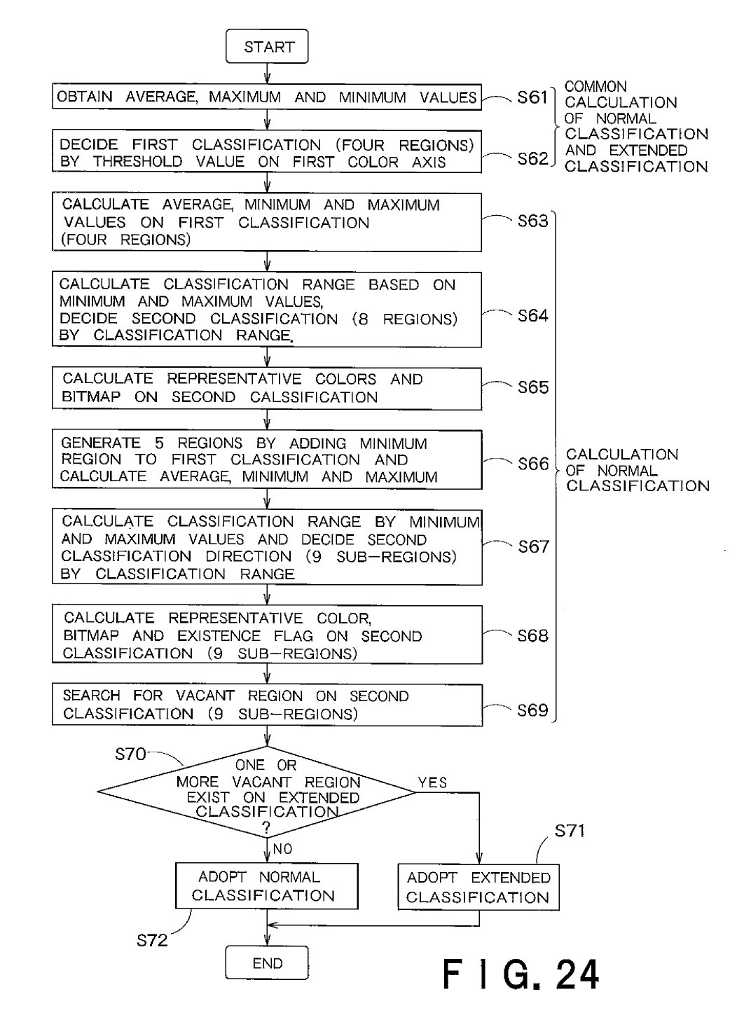

FIG. 24 is a flowchart showing an example of encoding according to the second embodiment.

First, color-component-wisely calculate the average value, the maximum value, and the minimum value for a single block (step S61). Second, perform four-classification along the first color axis, like as the first embodiment generates regions 1 to 4. Then, classify further the region 4 into two regions: an extended region 4′C and a region 4′ (step S62). Step S62 generates six (five) regions in total. Steps S61 and S62 are the common procedures applied to both normal and extended classification.

In this embodiment, a normal classification is performed to generate the region 4 in the same procedure as the first embodiment. An extended classification is performed to classify further the region 4 into an extended region 4′C and a region 4 (steps S66 to S69).

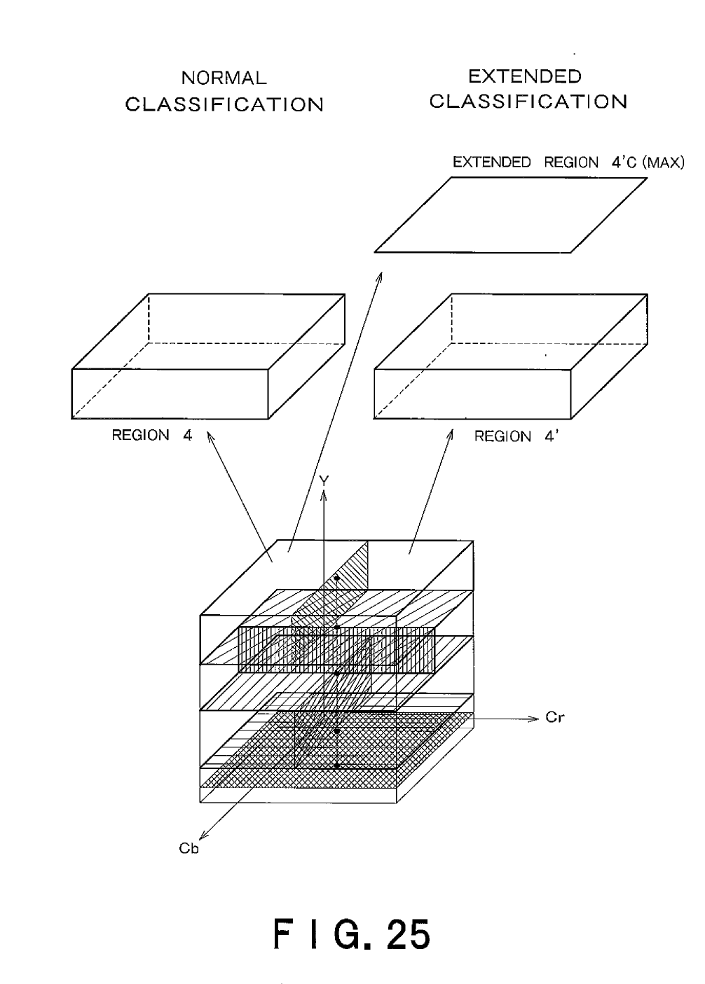

FIG. 25 illustrates the normal and extended classifications.

In the extended classification, classify 64 pixels of one block into the five regions, and calculate the average value, the maximum value, and the minimum value for each color component in each region (step S66).

Next, calculate the difference between the maximum and minimum values for each of the four regions, except for the extended region 4′C. Then, detect the spread of each color component and decide the color component with the largest spread as the second color axis direction for second classification (step S67).

Classify further each of the four regions, except for the extended region 4′C, into two along the secondary color axis. Thus, nine regions are generated in total. Then, classify 64 pixels in one block into the nine regions, and calculate a representative color and bitmap data for each region (step S68).

There may be a case where no pixel data exists for a region and the calculation is impossible for this region. Such a region is referred as “a vacant region”. When there is a vacant region, a value, for example, “0” is temporarily assigned as a component value of a representative color. Furthermore, an existence flag is set to “0” for indicating “vacancy” that means no data exists (“1” is assigned if data exists). The flag data is used to detect vacant regions in decoding.

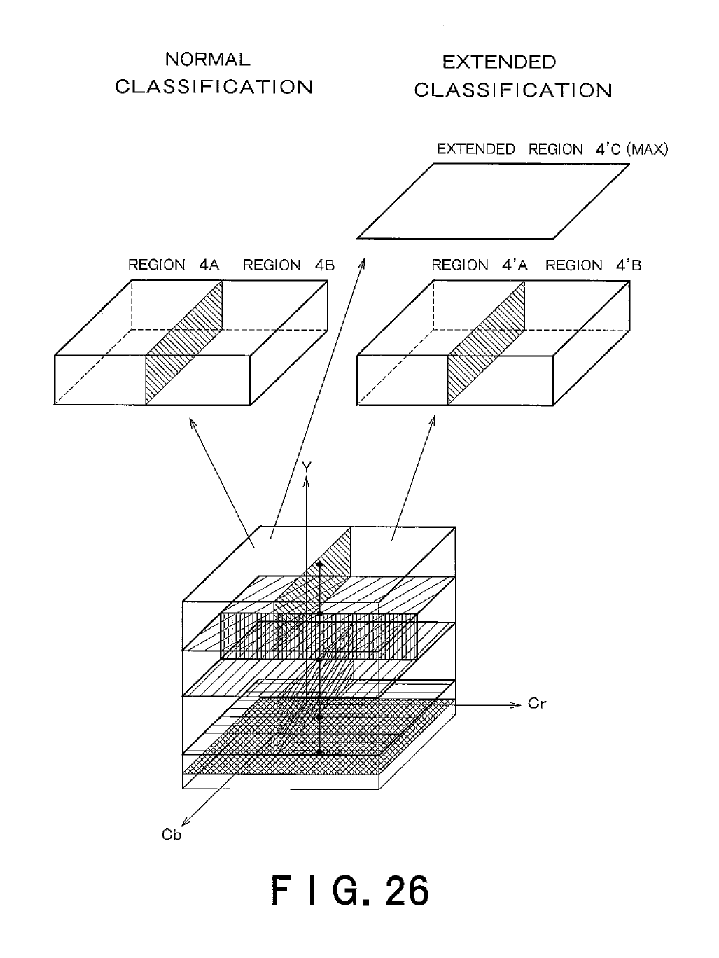

FIG. 26 shows the detail of step S68. While the extended region 4′C is not classified into two, each of the other regions 1 to 4 and the region 4′ is classified into two.

Next, determine whether there are vacant regions in the nine regions (steps S69 and S70). We say “vacancy is detected” when there is one or more of vacant regions. This is checked by the existence flags: if at least one existence flag indicates “vacant” for one of the regions. When vacancy is detected, the encoding is executed subject to the extended classification using the extended region 4′C and the region 4′ (step S71).

The encoding with the extended classification requires more regions than the first embodiment, hence causing increase in representative colors. Nevertheless, we need not to increase the number of bits in the bitmap data by the re-assignment: use the representative color originally assigned to a vacant region as a representative color assigned to a new region.

On the other hands, when pixels exist in all regions (no vacancy), the extended region 4′C is not used: Execute the encoding with eight regions, which is the same as the normal procedure in the first embodiment (step S72).

As described above, in the second embodiment, in order to prevent the case that similar colors are mixed in generation of a representative color, the extended classification divides the mixed-colors-region into two individual regions. Moreover, when there exits a vacant region in the finally generated regions, extended classification allocates the representative color given by extended classification to this vacant region. So, this treats the problem of mismatch between a representative color and an actual original color.

In an example explained above, the region 4 of the component Y is classified into the extended region 4′C and the region 4′. The component type of region for the extended classification may not necessarily be restricted to the component Y. The extended classification may preferably use another appropriate classification of regions, depending on the colors of pixels in a block.

In the example above described, we have described a scheme of extended classification in which one region is added to an (m×n) regions. Another scheme of extended classification of (m×n+2) regions may be available by additional region, where the additional region is generated by the minimum value of the component Y. When there are at least two vacant regions, the (m×n+2) region classification is adopted. In order to add regions, you may use another border value (threshold value) different from the above example. According to this idea, you may use an (m×n+p) extended regions by adding “p” regions (p being a positive integer). In this case, when “p” vacant regions are found, representative colors are used calculated from an (m×n+p) extended regions.

The second embodiment is then generalized as follows.

Calculate the minimum, maximum and average values of pixel values for pixels belonging to each of an (m+p) regions in total, where p is an integer of 1 or grater than 1. The (m+p) regions are obtained by the classification that is applied to the maximum region in m regions along the first color axis (a first color classification unit).

Calculate the representative color and bitmap for each of the (m×n+p) sub-regions (a second color classification unit).

When there is at least p vacant region in the (m×n+p) sub-regions, classify the pixels belonging to the (m×n+p) sub-regions by exploiting p region vacancy, and then generate the encoded data. When there is the vacant region less than p−1), generate the encoded data by using the (m×n) sub-regions (encoding unit).

### Third Embodiment

In the first and second embodiments, an example has been explained, which performs the encoding for a processing block with 8×8 pixels. The unit of processing block is not to be limited to 8×8 pixels. The third embodiment described below performs the encoding in a block with 4×4 pixels. A smaller processing unit of block leads to a smaller hardware complexity with a smaller storage capacity for the line memory 11, and with improving image quality. The third embodiment will control bit accuracy of a representative color of each of regions, when one block is classified into a plurality of regions.

In the third embodiment, to ensure the same compression rate as that of the first or second embodiment, one block is finally classified into four regions, and the representative colors are allocated to the maximum four colors.

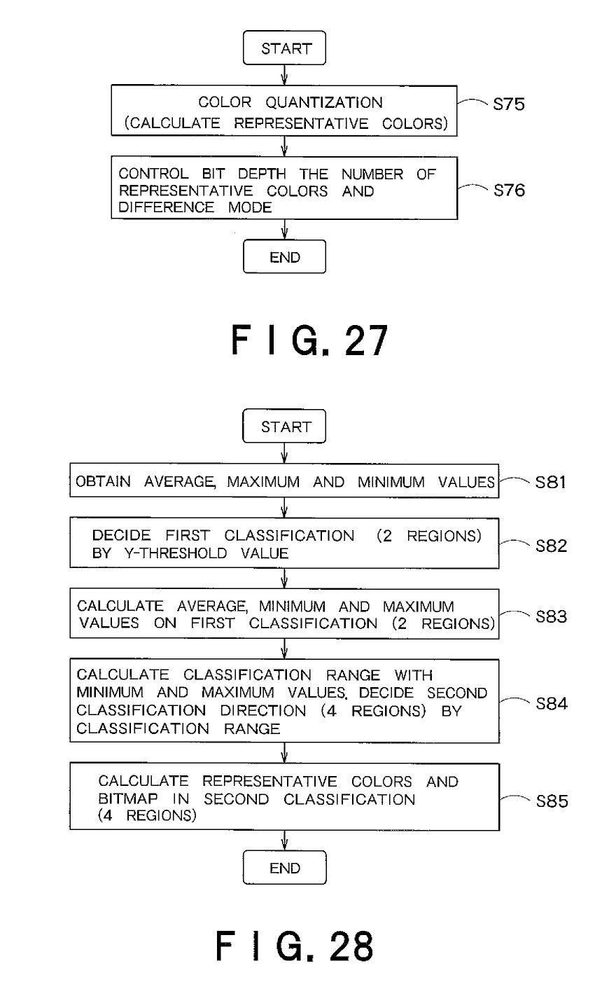

FIG. 27 is a flowchart showing an example of encoding according to the third embodiment.

Firstly, classify one block into two regions 1 and 2 along the first color axis direction. Next, classify each of the regions 1 and 2 along the second color axis direction. This second classification generates regions 1 to 4. Then, classify 16=4×4 pixels in one block into the regions 1 to 4. Finally, calculate a representative color for each region (step S75).

Then, as described later, execute the encoding which includes mode detection (difference mode or value mode) based on the total number of different representative colors in the regions 1 to 4 (step S76). In Step S76, delete vacant regions among the regions 1 to 4, which improves image quality.

FIG. 28 is a flowchart showing an example of detail of step S75 in FIG. 27. Firstly, calculate the average value, the maximum value, and the minimum value for 16=4×4 pixels in one block for each color component (step S81). Next, calculate a difference between the maximum and minimum values for each color component. Then, detect the spread of the color component, and select a color component having the largest spread as the first color axis. Finally, classify the block into two: two regions 1 and 2 are generated (step S82).

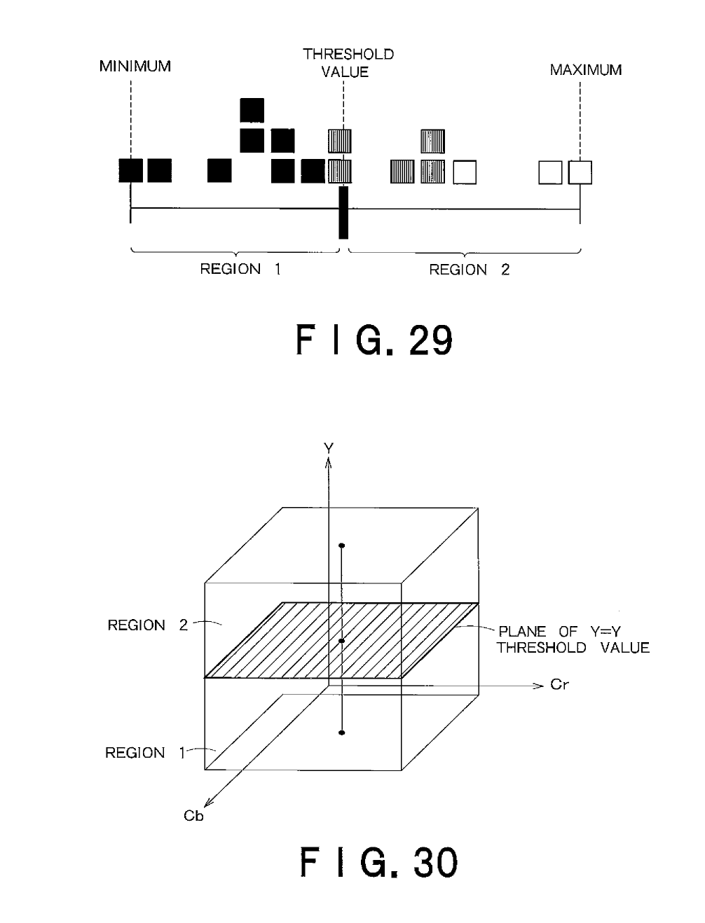

Then classify the 16 pixels in one block by the regions 1 and 2 generated in step S82, and calculate the average, maximum, and minimum values for each color component (step S83). FIG. 29 illustrates the procedure of step S82. For example, by using an average value as the threshold value, classify the 16 pixels into the regions 1 and 2.

Generate the regions 1 and 2 along the Y-component direction, as shown in FIG. 30, when the first color axis is along the Y-component direction.

Calculate the difference between the maximum and minimum values in step S83, and detect the spread of the color component. Then, select a color component having the largest spread as the second color axis (step S84). The second color axis is selected for each of the regions 1 and 2.

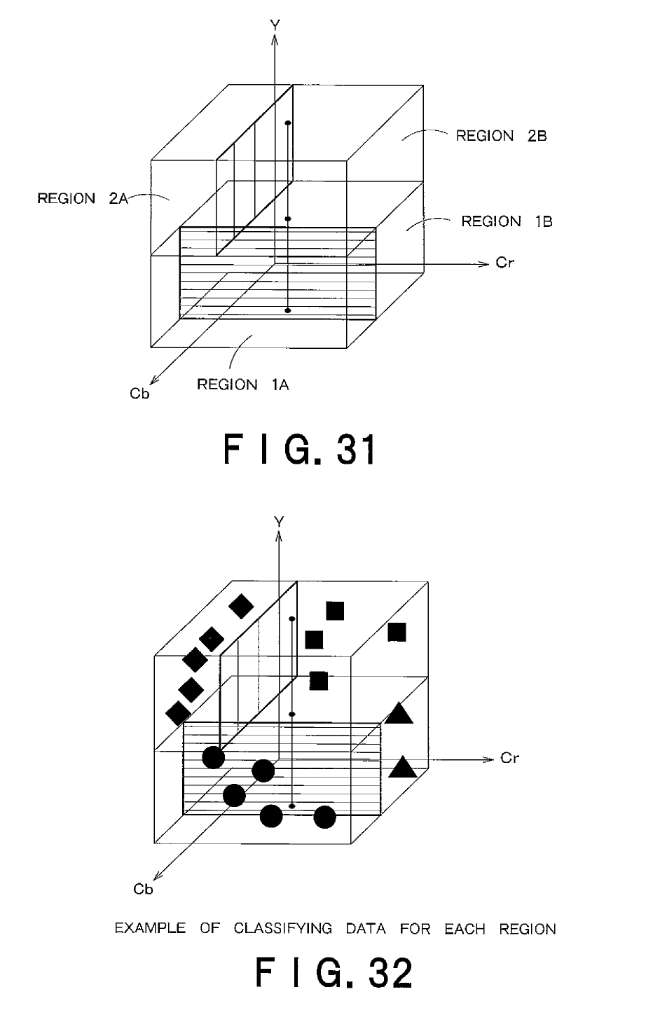

FIG. 31 illustrates the second classification along the secondary color axis. In FIG. 31, classify the region 1 into two along the Cb-component direction to generate regions 1A and 1B. Then, classify the region 2 into two in the Cr-component direction to generate regions 2A and 2B.

Next, classify the 16 pixels of one block into the regions 1A, 1B, 2A, and 2B. Calculate a representative color for each color component in each region. Then, generate bitmap data which shows the relations between the 16 pixels of one block and representative colors. (step S85).

FIG. 32 illustrates a classification example of 16 pixels into the regions 1A, 1B, 2A, and 2B. In FIG. 32, each pixel data is given with a symbol of black circle, black square, black triangle, or black rhombuses.

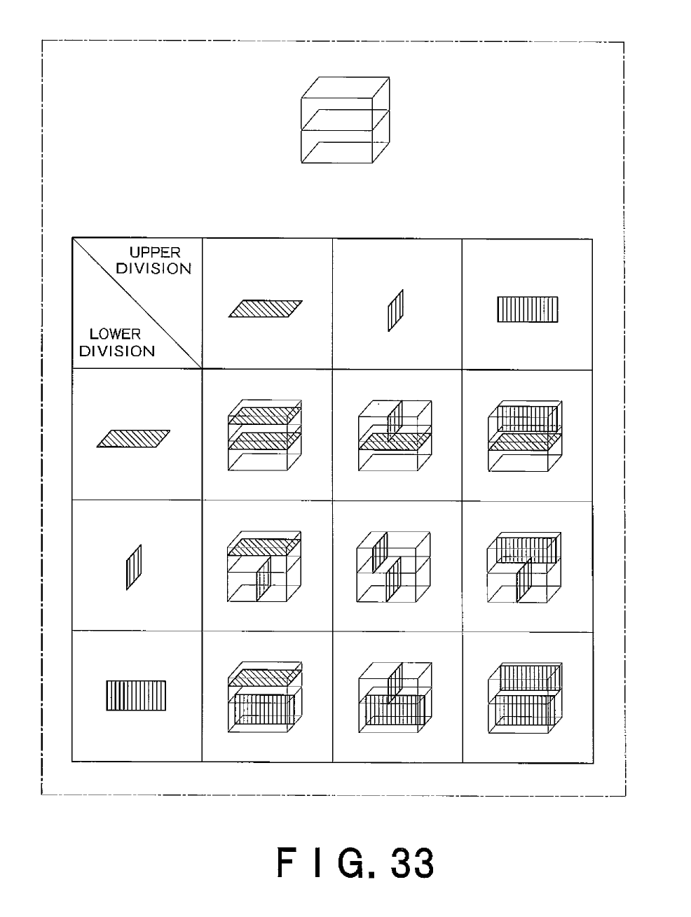

FIG. 33 illustrates two variations in the second classification of the regions 1 and 2, respectively. The second classification includes 9=3×3 combinations in total.

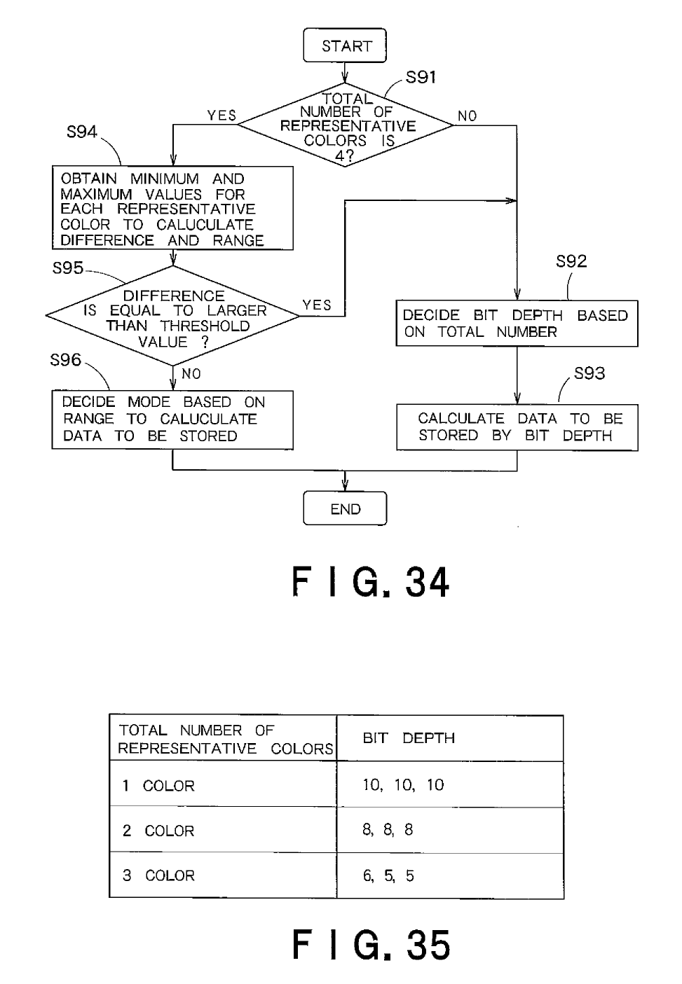

FIG. 34 is a flowchart indicating an example of detail of step S76 in FIG. 27.

First, determine whether the total number is four for representative colors allocated to the four regions 1A, 1B, 2A, and 2B (step S91). Select the value mode when the total number of representative colors is three or smaller. First of all, in the value mode, select bit accuracy decided by the total number of representative colors (stepS92). Step S91 is a determination process of representative-color.

The term “the total number of representative colors” means the detected total number of representative colors of pixel data that are actually found in region classification. In detail, the term “the total number of representative colors” means the actually effective number of representative colors, which varies for each block processing. But the term does not mean the pre-determined admissible maximum number of colors in the allocation of colors.

FIG. 35 illustrates the relation between the total number of representative colors and bit accuracy in the value mode. When the total number of representative colors is one, let each color component have 10 bits. When the total number of representative colors is two, let each color component have eight bits. When three, let the Y component have six bits, and let the Cb and Cr components have five bits.

After processing step S92, generate representative color data based on the selected bit accuracy (step S93).

On the other hands, when the total number of representative colors is found four in step S91, calculate a difference between the maximum and minimum values for each of the regions corresponding to the respective representative colors (step S94). Then, determine whether the difference is equal to or larger than the threshold value (step S95). Select the value mode is selected when the difference is equal to or larger than the threshold value. Then execute the steps S92 and S93. Step S95 determines difference-value.

When the difference is smaller than the threshold value, select a difference mode based on the difference-value. Then generate encoded data (step S96). As a summary, (1) when the total number of representative colors is four, the value mode is selected, (2) when the difference is equal to or larger than the threshold value, the difference mode is selected.

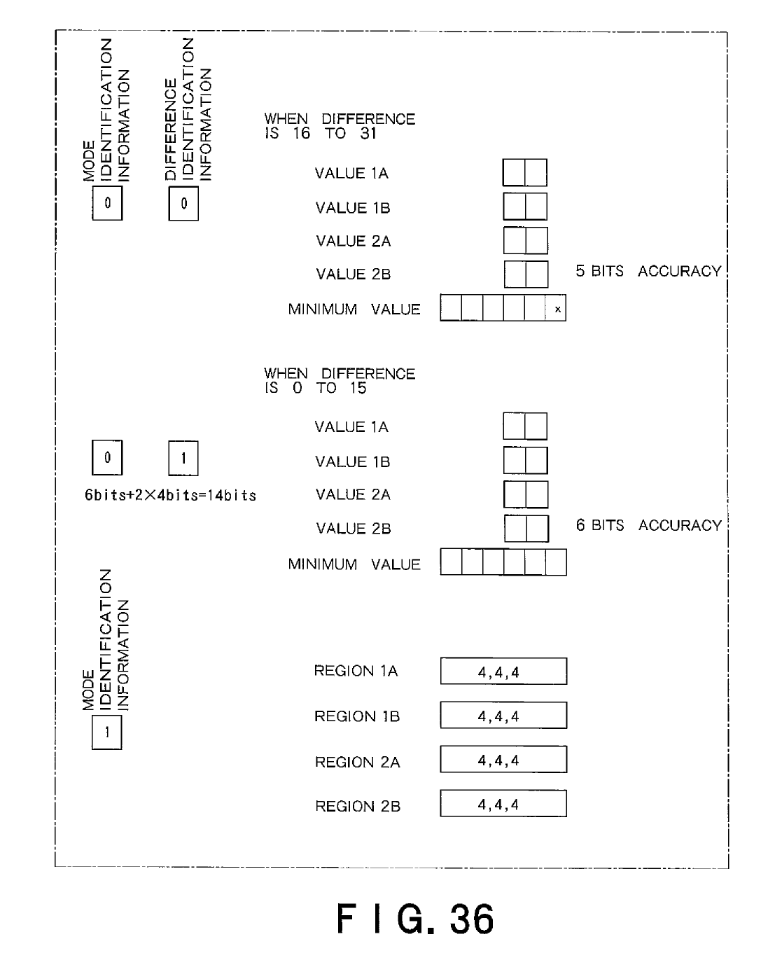

FIG. 36 illustrates the procedure when there are four representative colors for the four regions 1A, 1B, 2A, and 2B. We have two modes: difference mode and value mode. The mode is selected based on the difference between the representative colors. A 1-bit “mode identification data” is provided to identify a selected mode. The mode identification data of “0” means that the difference mode is selected. The mode identification data “1” means that the value mode is selected, for example. The value mode is selected when the difference is equal to 32 or larger than 32. The difference mode is selected when the difference is equal to 31 or smaller than 31.

When the difference mode is selected, select one from the two encoding types shown in FIG. 36, based on the difference. Then, in order to select the encoding type, 1-bit difference identification data is provided. When the difference identification data is “0”, the difference falls within the range 0 to 15. When the difference identification data is “1”, the difference falls within the range 16 to 31, for example.

When the difference falls within the region 16 to 31, the minimum value of representative colors of the four regions is given by 5-bit accuracy, and the representative color of each region is represented by two bits as the difference data from the minimum value. In this case, 13 (=5+2×4) bits are necessary.

When the difference falls within the range of 0 to 15, the minimum value of representative colors of the four regions is given by 6-bit accuracy, and representative color of each region is represented by two bits as the difference data from the minimum value. In this case, 14 (=6+2×4) bits are necessary.

As described above, one more bit is required for the case the difference falls within the region 0 to 15, compared to the case of the region 16 to 31. As we have 1-bit mode identification data and 1-bit difference identification data, the entire number of bits is 16 (=2+14) bits.

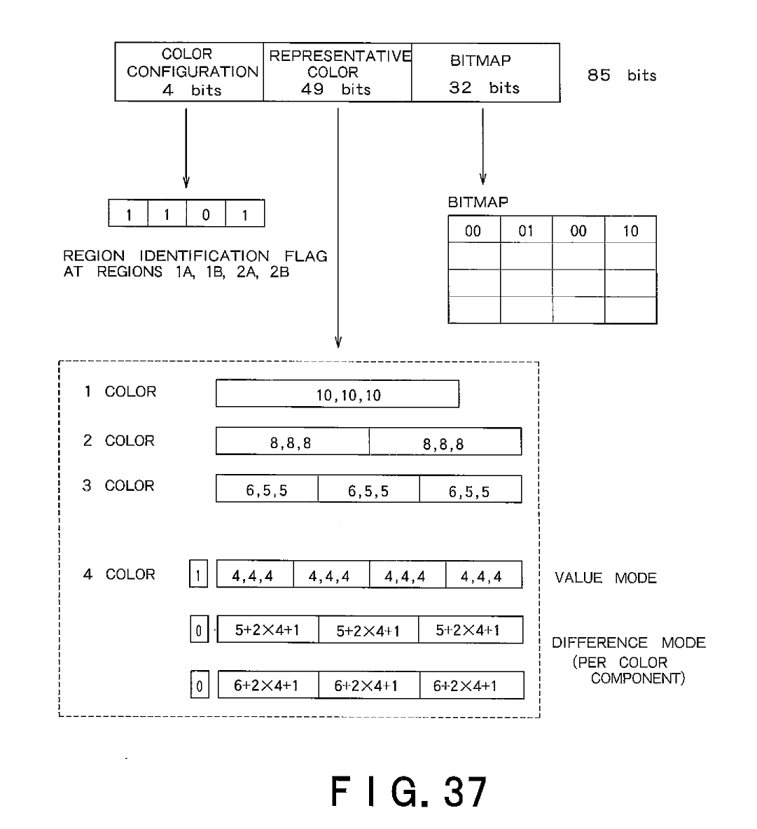

FIG. 37 illustrates an example of encoded data format in the third embodiment.

The encoded data shown in FIG. 37 is composed of followings: (1) 4-bit color configuration data that indicates whether pixels exist in the four regions 1A, 1B, 2A, and 2B, (2) 49-bit representative color data, and (3) 32-bit bitmap data. Thus, we have 85 (=4+49+32) bits in total.

The color configuration data is used for decoding encoded data. When some pixel exists in a specified region, color configuration data is “1” for the specified region. When no pixel exists in the region, “0” for the region.

The bitmap data includes pixel information of 16=4×4 pixels. Representative color is indicated by 2 bits. When there is a vacant region among the four regions, the total number of representative colors is three or smaller. Let the data on an unused representative color be not occurred in the bitmap data.

The number of bits of the representative color data is different, depending on the selected mode: difference mode or value modes.

When the value mode is selected, the representative color data is composed by following bits configuration, depending on the total number of representative colors:

30(=10+10+10) bits for one representative color in total;

48(=(8+8+8)×2) bits for two representative colors in total; and

48(=(6+5+5)×3) bits for three representative colors in total.

When the total number of representative colors is four, the representative color data requires 1-bit mode identification data. By addition 1 bit to 48 (=(4+4+4)×4) bits, thus we need 49 bits in total.

When the difference mode is selected, the representative color data has following configuration: 40 (=1+13×3) bits when the difference falls within the range 0 to 15; and 43 (=1+14×3) bits when the difference falls within the range 16 to 31.

Accordingly, the maximum number of bits for the encoded data is 85 (=4+49+32) bits in total, which includes 4-bit color configuration data, 49-bit representative color data, and 32-bit bitmap data.

On the other hand, original un-compressed image data has 480 (=(10+10+10)×4×4) bits for one block, because each color component has 10 bits accuracy.

Therefore, the third embodiment achieves a compression rate of 5.6=480/85, which is the same rate as that of the first embodiment.

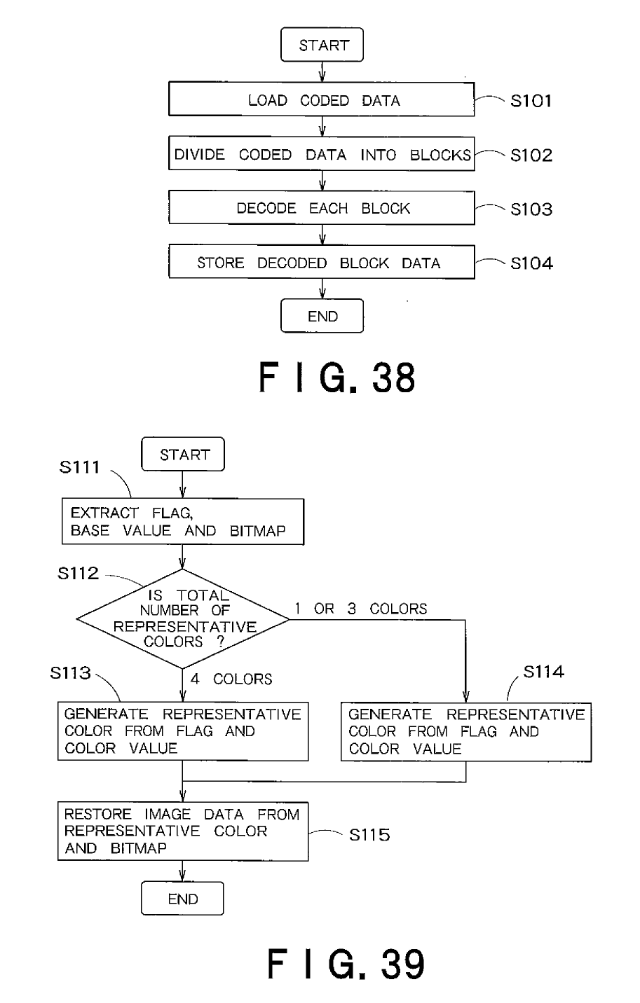

Next, a decoding in the third embodiment will be explained. FIG. 38 is a flowchart illustrating an example of decoding in the third embodiment. First, read encoded data from the FM 5 (step S101). Then, divide the encoded data block by block (step S102). Decode the encoded data block by block (step S103). Finally, store the decoded data in a memory (not shown) block by block (step S104).

FIG. 39 is a flowchart illustrating an example of detail of step S103 in FIG. 38. First, extract color configuration data, representative color data, and bitmap data from the encoded data (step S111). A fixed bit scheme is good to easily extract these encoded data. Although the representative color data may not necessarily have a fixed bit length as shown in FIG. 37, we will intentionally fix 49-bit length in advance for this embodiment. You may fill redundant un-used bit with a default bit value (0, for example).

Extract the 4-bit data from the color configuration data, and determine whether the total number of representative colors is 4 or falls within a range from 1 to 3 (step S112).

In order to find the total number of representative colors, calculate the total number of representative colors by the numerical addition of the existence flag data of “0” (non-existence) and “1” (existence) in the color configuration data. For example, a numerical addition “1 (existence)+1 (existence)+0 (non-existence)+1 (existence)=3” suggests three representative colors in total. When the total number of representative colors is four, at first, determine whether the mode is the difference or value mode, based on the bit value of the mode identification data included in the representative color data. We have two processing according to the mode (the difference mode or the value mode). Then, (1) for the difference mode, determine whether the difference falls within the range 0 to 15 or the range 16 to 31 based on the bit value of the difference identification data which is included in the representative color data. Thus, we have detected the number of bits of the minimum value. Next, add the difference value of each region to the minimum value in order to reconstruct the representative color of each region. (2) For the value mode, since the color components have four bits for each region, easily reconstruct the representative color of each region (step S113).

When step S112 determines whether the total number of representative colors falls within the range from 1 to 3, reconstruct the representative color for each region depending on the total number of representative colors, as shown in FIG. 37 (step S114).

After the completion of step S113 or S114, reconstruct image data based on the representative color of each region and the bitmap data (step S115).

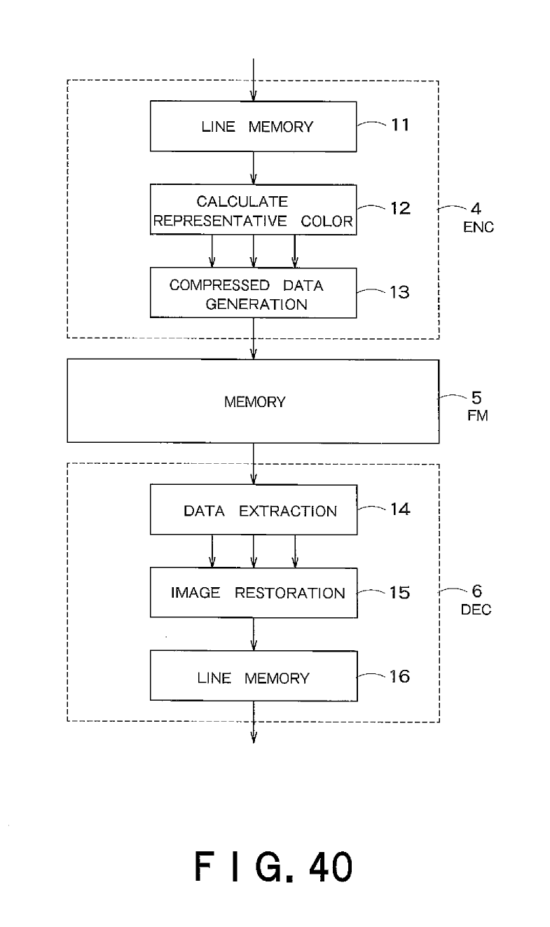

FIG. 40 shows an exemplary configuration of the ENC 4 in the third embodiment. The ENC 4 in FIG. 40 is provided with a representative color processing unit 17, which is replaced by the color quantization unit 12 in FIG. 2. The other components are the same as components in FIG. 2. The color quantization unit of FIG. 2 generates the quantization mode data, minimum-indicating bit data, and the minimum-value supplemental bit data. On the other hand, the representative color processing unit 17 generates the color configuration data, the mode identification data, and the difference identification data.

As described above, the third embodiment improves compression-ratio and image quality simultaneously because (1) the third embodiment has smaller block size than that of the first and second embodiments, (2) the third embodiment detects whether pixels exist in a plurality of regions obtained by classifying a block, and (3) the third embodiment performs compression that reduce the number of occurred vacant region as possible.

### Fourth Embodiment

The fourth embodiment is a modification to the third embodiment, achieving higher image quality than the third embodiment. The third embodiment adopts the difference mode only when the total number of representative colors is 4. In the third embodiment, a mode is fixed to “value mode” when the total number of representative color is 3. In the third embodiment, we have the accuracy of 6 bits for the component Y and 5 bits for the components Cb and Cr.

The fourth embodiment described below admits the difference mode, even when the total number of representative colors is three, in order to further improve image quality.

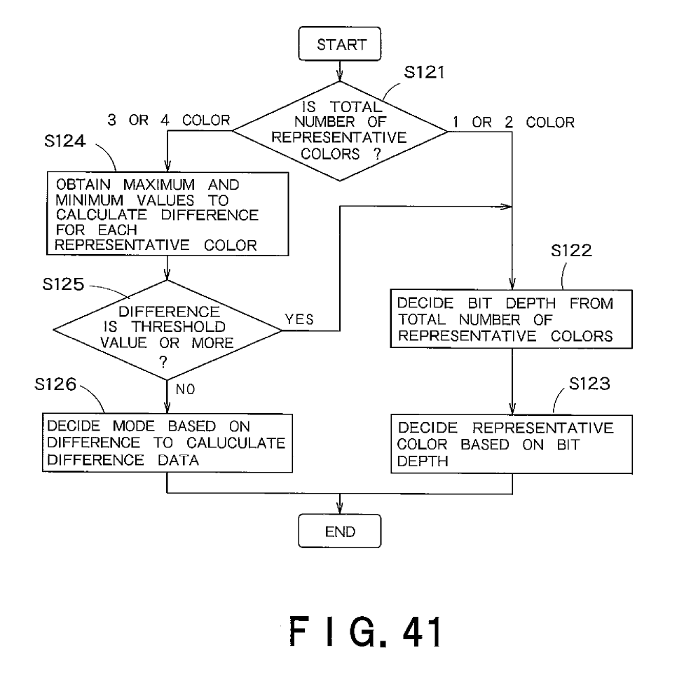

FIG. 41 is a flowchart illustrating an encoding according to the fourth embodiment.

Firstly, determine whether the total number of representative colors falls within the range 1 or 2, or within the range 3 or 4 (step S121). The term “the total number of representative colors” means the total number of representative colors of pixel data that actually exist, as a result number of confirming whether the pixel data actually exists by the region classification.

When the total number of representative colors is either 1 or 2, execute the same procedures as steps S92 and S93 of FIG. 34 to encode the representative color by the specified bit accuracy. This bit accuracy is determined in advance based on the total number of representative colors (steps S122 and S123).

On the other hand, when the total number of representative colors is 3 or 4 in step S121, calculate a difference between the maximum and minimum values for each region and for each color components corresponding to a representative color (step S124). Then, determine whether the difference is equal to or larger than a threshold value 8 for example (step S125). When the difference is determined as equal to or larger than 8, execute the step S122 for adopting the value mode. When the difference is smaller than 8, change the bit accuracy of the minimum value based on the difference (step S126).

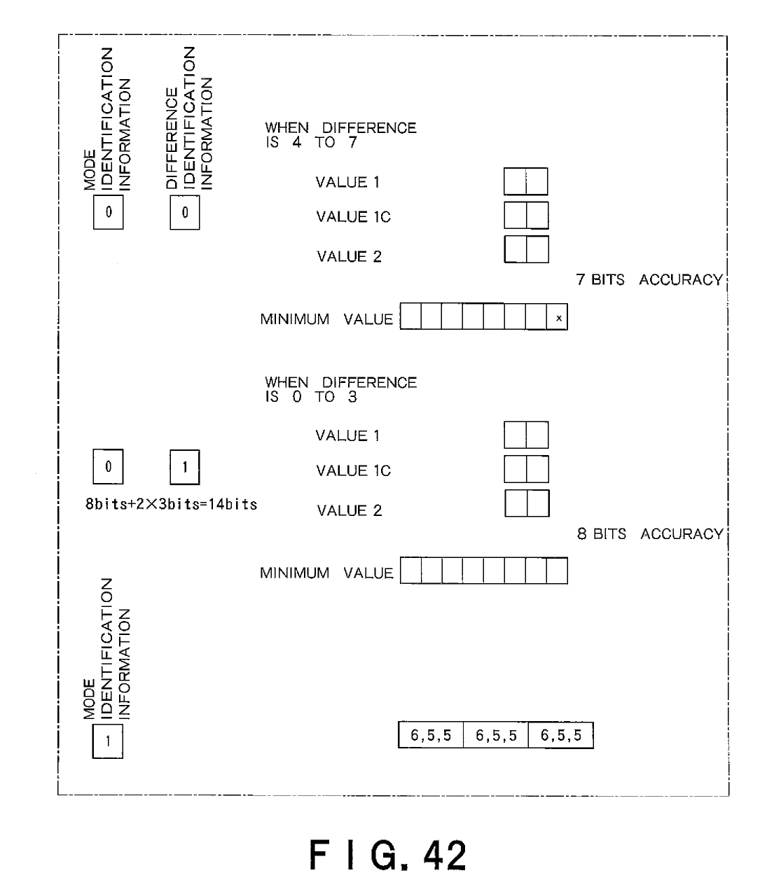

FIG. 42 illustrates an example of step S126 when representative colors are three in total. When the difference is equal to 7 or is smaller than 7, set the mode identification data to 0, in order to select the difference mode. When the difference falls within the range from 0 to 3, set the mode identification data to 0. Let the minimum value to have 8-bit accuracy. Let the difference between the maximum and minimum values in each region to have two bits. When the difference falls within the range from 4 to 7, set the difference identification data to 1. Give two bits in order to represent the difference between the maximum and minimum values in each region.

When the difference is equal to 8 or is larger than 8, set the mode identification data to 1, to select the value mode. In this case, each of the representative colors is given by 6 bits for the component Y and by 5 bits each for the components Cb and Cr.

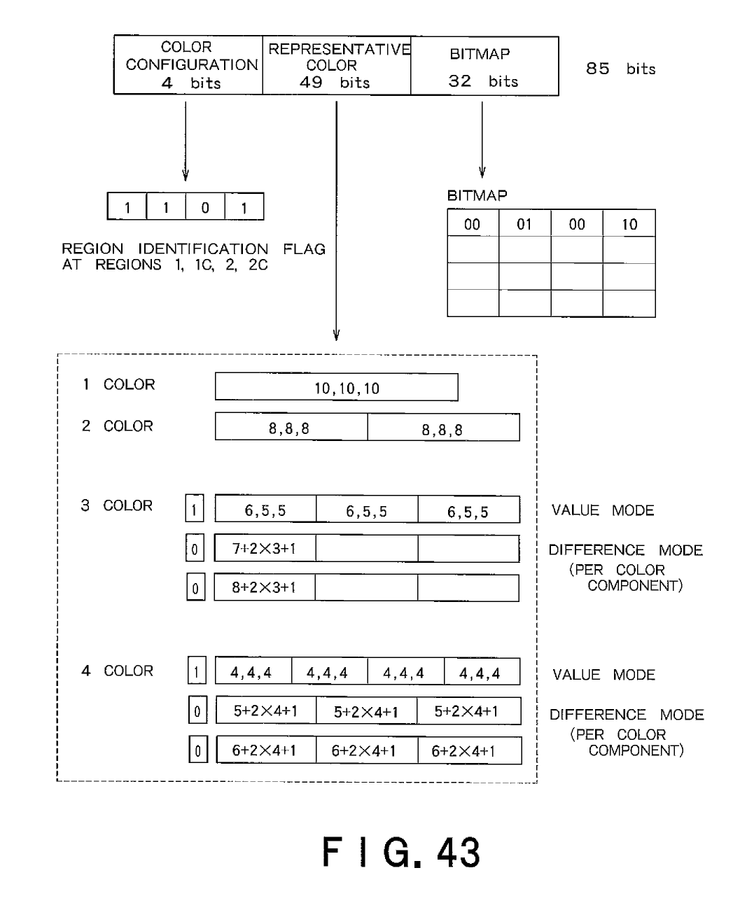

FIG. 43 illustrates an example of an encoded data format in the fourth embodiment. As compared with FIG. 37, representative information is different when representative colors are three in total. The other part in FIG. 43 is the same as one in FIG. 37 respectively.

The third and fourth embodiments allocate fixed 2 bits to each pixel under the pre-assumption that the bitmap data treats 4 colors. However, when a total number of representative colors is equal to 3 or is smaller than 3, all of the bits are not used effectively for each pixel, because 2 bits are always allocated to each pixel. This fixed bit scheme causes waste of bits. In order to avoid this waste, we will adopt an approach that we have variable (not fixed) number of bits in the bitmap data depending on the number of representative colors.

For instance, suppose that the number of representative colors is equal to 3. Considering on three neighboring pixels, the color combinations are 27 (=3×3×3) because each pixel may have any of the three colors. When the bitmap data is 2 bits for each pixel, 6 bits are need for 3 pixels to achieve 32 color combinations. As a result, 5 (=32−27) bits corresponds to waste.

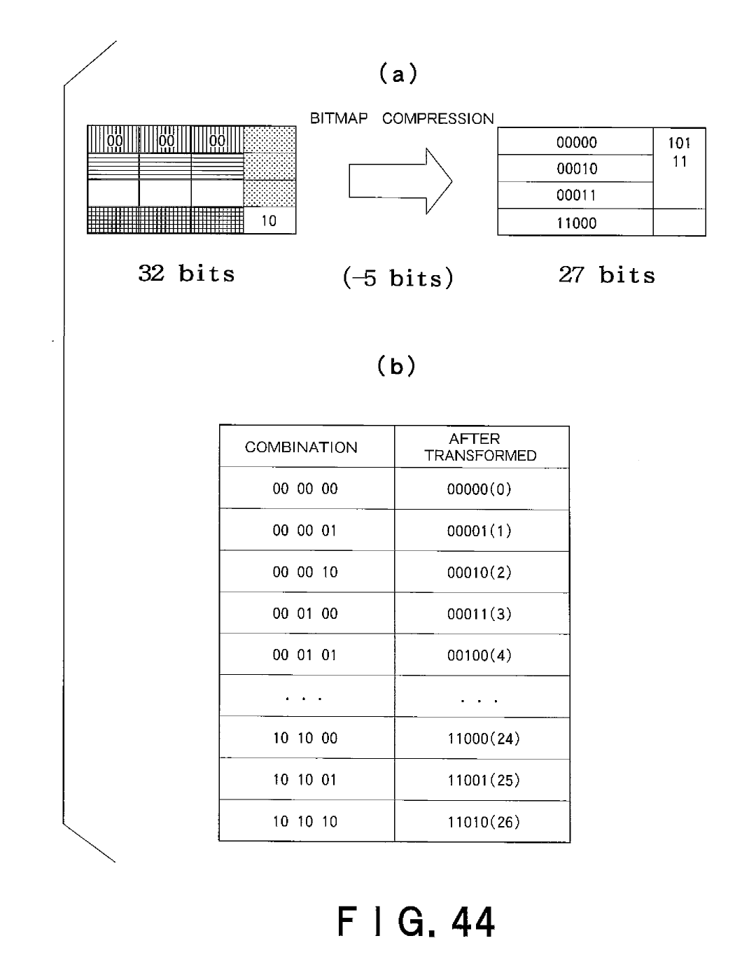

In order to reduce such a waste, we will compress 6 bits to 5 bits for 3 pixels. As single block contains 16 (=4×4) pixels, compress bits by grouping 3 pixels. Then, we have finally 5 groups and remainder of one pixel, as shown in FIG. 44 (a). Each of the 5 groups has 5 bits, and the remainder of one bit has 2 bits.

Accordingly, as there are 25 (=5×5) bits for the total number in the 5 groups, and as 2 bits for the remainder one bit, we have 27 bits for bitmap data in total, thereby achieving reduction of 5 (=32−27) bits.

When bitmap data is compressed as described above, it is preferable to modify the bit value indicating a representative color by omitting allocation of a vacant region.

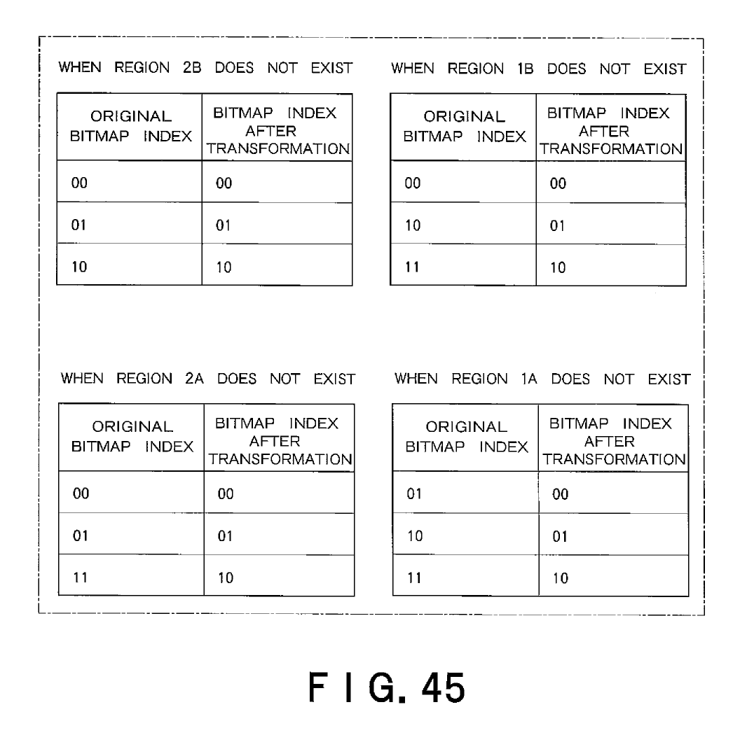

For example, FIG. 45 shows an example of bitmap modification of bitmap data when representative colors are three in total. It is possible to efficiently compress the bitmap data by the following: omit the bit data of a representative color for the vacant region, and indicate the other representative colors by predetermined three values of bits 00, 01, and 10.

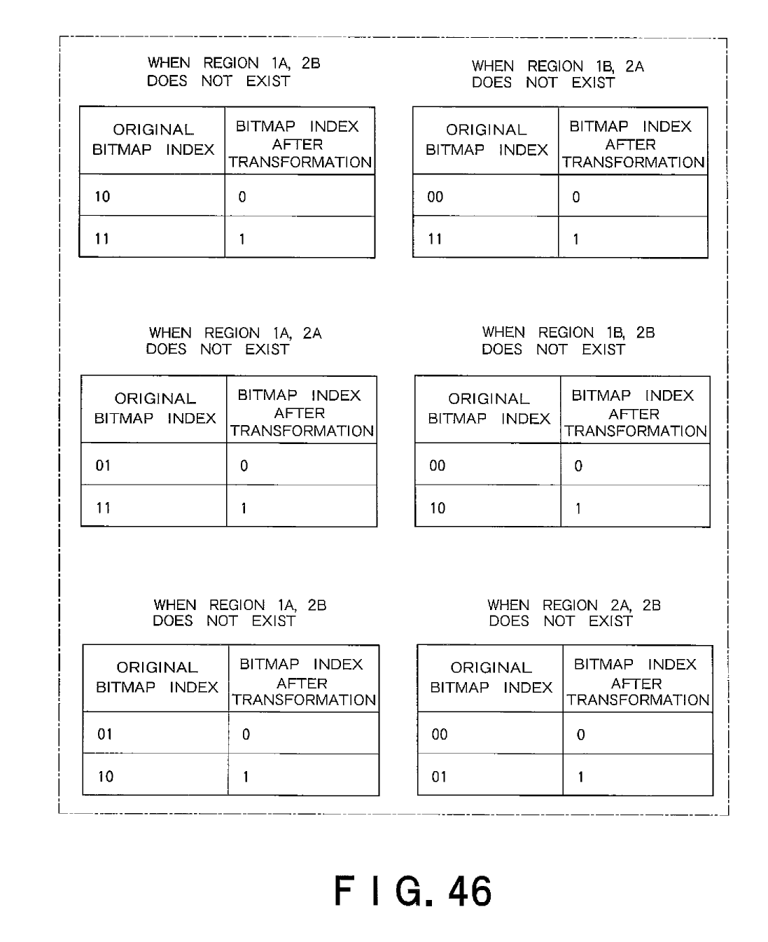

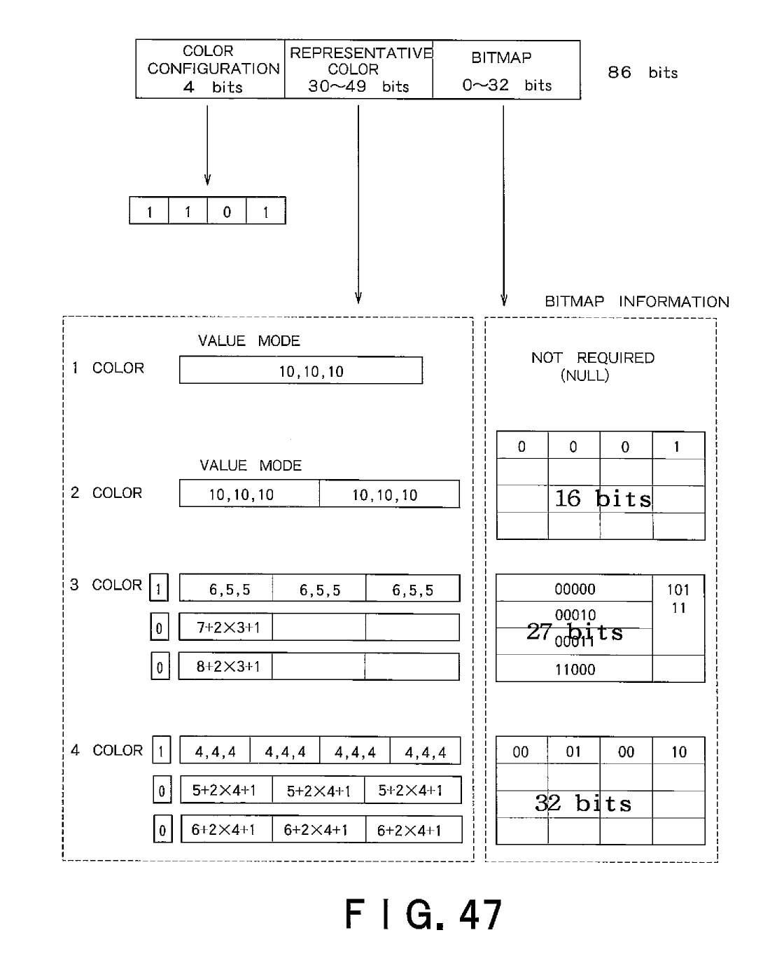

FIG. 46 shows another example of bitmap modification when two representative colors in total. Shown in FIG. 46 as there are two representative colors represented by one bit, let the bitmap data indicating representative color to have one bit.

FIG. 47 shows an example of an encoded data format when the procedures FIGS. 44 to 46 compress bitmap data. The difference of the data format in FIG. 47 from FIG. 43 is that the total number of bits in the bitmap data varies depending on the total number of representative colors.

Decode the encoded data shown in FIG. 47 as follows: The total number of encoded data bits varies depending on the total number of bits of bitmap data. Detect the total number of representative colors by color configuration data. More specifically, add the existence flag as numerical data (“0” and “1” as number) in the configuration data. As compression algorithm of bitmap data is different depending on the total number of representative colors, when the total number is found for the representative colors, decode the bitmap data which indicate the representative color of each pixel.

As described above, in the fourth embodiment, we decide bit configuration of the representative color information by the total number of representative colors and the maximum-to-minimum value difference between the representative colors. Thus we have improved image quality and efficiently compressed the representative the coded data. Also in the fourth embodiment, when the block is classified into a plurality of regions, the bitmap data is not allocated to the vacant region, thereby the bitmap data is efficiently compressed.

The third and fourth embodiments have described an example in which the number of the representative colors is equal to four as the maximum representative colors. However, the number of the representative colors is not restricted to the above example. The third and fourth embodiments are generalized as follows.

Determine whether the total number of representative colors to be allocated to m×n regions is equal to or larger than “k”, where k is equal to or less than a positive integer of m×n) (a representative color number determination unit).

When the total number of representative colors is equal to or larger than “k”, determine whether the difference between the representative colors of the m×n sub-regions is equal to or larger than a predetermined threshold value, for each color or each color-difference component (a difference value determination means).

When the difference is determined as smaller than the threshold value, encode the pixel values of a plurality of pixels in a pixel block corresponding to the m×n regions in order to generate coded data, based on the differences between the representative values corresponding to the representative colors in the m×n sub-regions. When the difference is equal to or larger than the threshold, using the pre-determined bit accuracy generate the encoded data. This bit accuracy is predetermined by a total number of the representative colors for the (m×n) sub-regions (encoding means).

While some embodiments have been described, these embodiments have been presented by example, and are not intended to limit the scope of the inventions. Indeed, the other novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and sprit of the invention.

1. An encoder comprising:
a first color sorting unit configured to classify along a first color axis, each of pixel blocks each having an inputted plurality of pixels, into m regions where m is an integer of two or more, to classify the plurality of pixels in each of the pixel blocks into the m regions, and to calculate a minimum value, a maximum value and an average value of pixel values belonging to each of the m regions for each of the m regions; and
a second color sorting unit configured to classify along a second axis selected based on a calculation of the first color sorting unit, each of the m regions into n sub-regions where n is an integer of two or more, for each of the m regions, to classify the plurality of pixels in the pixel block into (m×n) sub-regions, and to calculate coded information corresponding to representative colors allocated to pixel locations in an original pixel block and bitmap information of the representative colors; and
an encoding unit configured to generate encoded data of the pixel values of the plurality of pixels in the pixel block corresponding to the (m×n) sub-regions based on differences between the representative values corresponding to the representative colors in the (m×n) sub-regions.

2. The encoder according to claim 1, wherein the bitmap information is information indicating the sub-region where each pixel in the original pixel block belongs.

3. The encoder according to claim 1, wherein:
the first color sorting unit detects spread of each color component for each color component or each color difference component in the pixel block, to decide a color direction or a color difference direction having a maximum value of the detected spread as the first color axis; and
the second color sorting unit detects spread of each color component for each color component or each color difference component for each of the m regions, to decide a color direction or a color difference direction having a maximum value of the detected spread as the second color axis.

4. The encoder according to claim 1, wherein the coding unit generates the coded data, the coded data comprises:
quantization mode information decided by the differences between the representative values corresponding to the representative colors in the (m×n) sub-regions;
information expressing a minimum value of the representative values in the (m×n) sub-regions; and
minimum-value supplemental bit information required for setting the minimum value to predetermined bit accuracy.

5. The encoder according to claim 1, wherein:
the first color sorting unit calculates the minimum value, the maximum value and the average value of the pixel values in each region for each of (m+p) regions where p is an integer of 1 or more, the (m+p) sub-regions being obtained by classifying an region having a maximum value on the first color axis in the m regions;
the second color sorting unit calculates the representative value and the bitmap information for each of (m×n+p) sub-regions; and
when there is a p vacant region having no pixel in the (m×n+p) sub-regions, the coding unit re-classifies the pixels belonging to the (m×n+p) sub-regions by using the p vacant region to generate the coded data, and generates the coded data by using the (m×n) sub-regions when there is the vacant region less than (p−1) pieces.

6. The encoder according to claim 5, wherein the coding unit generates the coded data, the coded data comprises:
mode identification information indicating whether the coded data is generated based on the differences between the representative values corresponding to the representative colors in the (m×n) sub-regions, or the representative values are encoded with the number of bits predetermined in accordance with the number of the representative colors; and
difference identification information classified by the differences when the coded data is generated based on the differences.

7. The encoder according to claim 1, further comprising:
a representative color number determination unit configured to determine whether a total number of the representative colors allocated to each of the (m×n) sub-regions is k or more where k is a positive integer of (m×n) or less; and
a difference value determination unit configured to determine whether each of differences between the representative values corresponding to the representative colors in the (m×n) sub-regions is equal to or more than a predetermined threshold value for each color or each color difference when a total number of the representative colors is k or more,
wherein the coding unit generates the coded data of the pixel values of the plurality of pixels in the pixel block depending on the differences between the representative values corresponding to the representative colors in the (m×n) sub-regions when determined to be less than the threshold value, and generates the coded data of the pixel values of the plurality of pixels in the pixel block at bit accuracy predetermined by a total number of the representative colors for the (m×n) sub-regions when determined to be equal to or more than the threshold value, or when determined to be less than k.

8. A display controller comprising:
an encoder configured to generate coded data based on image data containing color information or color difference information;
a storage configured to store the coded data;
a decoder configured to decode the coded data read out from the storage, to generate new image data; and
an overdrive unit configured to compare inputted image data with one-frame previous image data for each pixel, to control gradation voltages provided to a display panel in accordance with a compared result,
wherein the encoder comprises a color sorting unit configured to divide each of pixel blocks each having an inputted plurality of pixels, into m regions where m is an integer of two or more, to classify the plurality of pixels in each of the pixel blocks into the m regions, and to calculate coded information corresponding to representative colors allocated to pixels locations in an original pixel block and bitmap information of the representative colors, and
the decoder comprises:
a dividing unit configured to divide the coded data read out from the storage into each of blocks; and
a restoring unit configured to replace a each color of the pixels in each of the blocks with a representative color based on the coded information corresponding to the representative color and the bitmap information of the representative color for each of the m regions, to reconstruct the image data and provide the reconstructed image data to the overdrive unit as one-frame previous image data.

9. The display controller according to claim 8, wherein the color sorting unit comprises:
a first color sorting unit configured to calculate a minimum value, a maximum value and an average value of pixel values belonging to each of the m regions for each of the m regions; and
a second color sorting unit configured to divide along a second axis selected based on a calculation of the first color sorting unit, each of the m regions into n sub-regions where n is an integer of two or more, for each of the m regions, to classify the plurality of pixels in the pixel block into (m×n) sub-regions, and to calculate coded information corresponding to representative colors allocated to pixel locations in an original pixel block and bitmap information of the representative colors; and
an encoding unit configured to generate coded data of the pixel values of the plurality of pixels in the pixel block corresponding to the (m×n) sub-regions based on differences between the representative values corresponding to the representative colors in the (m×n) sub-regions.

10. The display controller according to claim 9, wherein:
the first color sorting unit detects spread of each color component for each color component or each color difference component in the pixel block, to decide a color direction or a color difference direction having a maximum value of the detected spread as the first color axis; and
the second color sorting unit detects spread of each color component for each color component or each color difference component for each of the m regions, to decide a color direction or a color difference direction having a maximum value of the detected spread as the second color axis.

11. The display controller according to claim 9, wherein the coding unit generates the coded data, the coded data comprises:
quantization mode information decided by the differences between the representative values corresponding to the representative colors in the (m×n) sub-regions;
information expressing a minimum value of the representative values in the (m×n) sub-regions; and
minimum-value supplemental bit information required for setting the minimum value to a predetermined bit accuracy.

12. The display controller according to claim 9, wherein:
the first color sorting unit calculates the minimum value, the maximum value and the average value of the pixel values in each region for each of (m+p) regions where p is an integer of 1 or more, the (m+p) sub-regions being obtained by dividing an region having a maximum value on the first color axis in the m regions;
the second color sorting unit calculates the representative value and the bitmap information for each of (m×n+p) sub-regions; and
when there is p vacant region having no pixel in the (m×n+p) sub-regions, the coding unit re-classifies the pixels belonging to the (m×n+p) sub-regions by using the p vacant region to generate the coded data, and generates the coded data by using the (m×n) sub-regions when there is the vacant region less than (p−1) pieces.

13. The display controller according to claim 12, wherein the coding unit generates the coded data, the coded data comprises:
mode identification information indicating whether the coded data is generated based on the differences between the representative values corresponding to the representative colors in the (m×n) sub-regions, or the representative values are encoded with the number of bits predetermined in accordance with the number of the representative colors; and
difference identification information classified by the differences when the coded data is generated based on the differences.

14. The display controller according to claim 9, further comprising:
a representative color number determination unit configured to determine whether a total number of the representative colors allocated to each of the (m×n) sub-regions is k or more where k is a positive integer of (m×n) or less; and
a difference value determination unit configured to determine whether each of differences between the representative values corresponding to the representative colors in the (m×n) sub-regions is equal to or more than a predetermined threshold value for each color or each color difference when a total number of the representative colors is k or more,
wherein the coding unit generates the coded data of the pixel values of the plurality of pixels in the pixel block depending on the differences between the representative values corresponding to the representative colors in the (m×n) sub-regions when determined to be less than the threshold value, and generates the coded data of the pixel values of the plurality of pixels in the pixel block at bit accuracy predetermined by a total number of the representative colors for the (m×n) sub-regions when determined to be equal to or more than the threshold value, or when determined to be less than k.

15. A coding method comprising:
dividing along a first color axis, each of pixel blocks each having an inputted plurality of pixels, into m regions where m is an integer of two or more, to classify the plurality of pixels in each of the pixel blocks into the m regions, and to calculate a minimum value, a maximum value and an average value of pixel values belonging to each of the m regions for each of the m regions as a first color sorting process; and
dividing along a second axis selected based on a calculation of the first color sorting process, each of the m regions into n sub-regions where n is an integer of two or more, for each of the m regions, to classify the plurality of pixels in the pixel block into (m×n) sub-regions, and to calculate coded information corresponding to representative colors allocated to pixel locations in an original pixel block and bitmap information of the representative colors as a second color sorting process; and
generating coded data of the pixel values of the plurality of pixels in the pixel block corresponding to the (m×n) sub-regions based on differences between the representative values corresponding to the representative colors in the (m×n) sub-regions.

16. The coding method according to claim 15, wherein:
the first color sorting process detects spread of each color component for each color component or each color difference component in the pixel block, to decide a color direction or a color difference direction having a maximum value of the detected spread as the first color axis; and
the second color sorting process detects spread of each color component for each color component or each color difference component for each of the m regions, to decide a color direction or a color difference direction having a maximum value of the detected spread as the second color axis.

17. The coding method according to claim 15, wherein the coded data comprises:
quantization mode information decided by the differences between the representative values corresponding to the representative colors in the (m×n) sub-regions;
information expressing a minimum value of the representative values in the (m×n) sub-regions; and
minimum-value supplemental bit information required for setting the minimum value to a predetermined bit accuracy.

18. The coding method according to claim 15, wherein:
the first color sorting process calculates the minimum value, the maximum value and the average value of the pixel values in each region for each of (m+p) regions where p is an integer of 1 or more, the (m+p) sub-regions being obtained by dividing an region having a maximum value on the first color axis in the m regions;
the second color sorting process calculates the representative value and the bitmap information for each of (m×n+p) sub-regions; and
when there is p vacant region having no pixel in the (m×n+p) sub-regions, the pixels belonging to the (m×n+p) sub-regions are resorted by using the p vacant region to generate the coded data, and the coded data is generated by using the (m×n) sub-regions when there is the vacant region less than (p−1) pieces.

19. The coding method according to claim 18, wherein the coded data comprises:
mode identification information indicating whether the coded data is generated based on the differences between the representative values corresponding to the representative colors in the (m×n) sub-regions, or the representative values are encoded with the number of bits predetermined in accordance with the number of the representative colors; and
difference identification information classified by the differences when the coded data is generated based on the differences.

20. The coding method according to claim 15, further comprising:
determining whether a total number of the representative colors allocated to each of the (m×n) sub-regions is k or more where k is a positive integer of (m×n) or less; and
determining whether each of differences between the representative values corresponding to the representative colors in the (m×n) sub-regions is equal to or more than a predetermined threshold value for each color or each color difference when a total number of the representative colors is k or more,
wherein the coded data of the pixel values of the plurality of pixels in the pixel block is generated depending on the differences between the representative values corresponding to the representative colors in the (m×n) sub-regions when determined to be less than the threshold value, and the coded data of the pixel values of the plurality of pixels in the pixel block is generated at bit accuracy predetermined by a total number of the representative colors for the (m×n) sub-regions when determined to be equal to or more than the threshold value, or when determined to be less than k.
